(19) United States
(12) Patent Application Publication
(10) Pub. No.: US 2007/0128905 A1
(43) Pub. Date: Jun. 7, 2007

(54) Transparent conducting structures and methods of production thereof

(76) Inventor: Stuart Speakman, Essex (GB)

Correspondence Address: MINTZ LEVIN COHN FERRIS GLOVSKY & POPEO, 666 THIRD AVENUE, NEW YORK, NY, 10017, US

(21) Appl. No.: 10/560,547

(22) PCT Filed: Jun. 11, 2004
(86) PCT No.: PCT/GB04/02545

§ 371 Date: Aug. 9, 2006

(30) Foreign Application Priority Data
Jun. 12, 2003 (GB) 0313617.3
Feb. 6, 2004 (GB) 0402687.8

(51) Int. Cl. H01R 13/20

(52) U.S. Cl. 439/161

(57) ABSTRACT

Transparent electrical conductors comprising regions of high transparency and regions of lower transparency, but higher conductivity. This allows electrical connection through the conductor, while retaining its transparency for such applications as hand-held device display screens or transparent antennas, for example.

### INTRODUCTION

The present invention relates to transparent conducting structures and more particularly to methods of producing transparent conducting structures.

Transparent conducting thin films in the form of inorganic and intrinsically conducting organic coatings, such as Antimony Tin Oxide (ATO), ITO, and polyaniline, are currently employed in a wide range of electro-optic devices that include electrodes for flat panel displays, electro-optic switches, and integrated optoelectronic circuits. The selected transparent conductor is generally deposited as a whole area coating and then subsequently patterned using conventional photolithographic patterning techniques in conjunction with liquid (i.e., HCl, etc.) or dry etchants (i.e., reactive ion beams or reactive ion plasmas including He, H₂, CH₄, O₂, HBr, Cl₂, etc.). It is also known that pulsed laser techniques can be used to both subtractively pattern, as well as, additively pattern such coatings. In all cases the nature of the patterning technique is either expensive due to the capital nature of the equipment being used when considering sample throughput or requires many processing steps that are labour intensive and affect the useable yield. It is known that screen-printing can be used to produce patterned transparent conductors but this technique has limitations with respect to feature resolution and minimum thickness.

In its preferred forms, the present invention seeks to address the limits of the processes outlined above by considering thin film materials, device configurations, and advanced printing processes that lend themselves to direct patterning.

There is therefore provided as one aspect of the invention, an electrical conductor having a region comprising transparent electrically conductive material having dispersed therein electrically conductive particles formed from material having a higher conductivity than the transparent material. This takes advantage of the much lower electrical resistivity of the electrically conducting particles and the high optical transmissivity of the transparent (though less conducting) particles and combines them to give a highly transparent, highly conducting transparent conductor.

This conductor design opens up the possibility of achieving the best of metal conductors and transparent conductors

As described herein, an electrical conductor or device comprises any device or material which is capable of conducting electricity when a potential difference is present across whole or part of that device or material. Similarly an electrically conductive device, material or track comprises any device, material, or track which is capable of conducting electricity when a potential difference is present across whole or part of that device, material or track. Such electrical conductors or electrically conductive device, materials, or tracks include devices, materials, or tracks having significant electrical resistivities. Such electrical resistivities may be of the order of between 10⁻⁶ Ω-cm and 10⁻² Ω-cm, across all or part of such devices, materials or tracks, but may be very much greater, for instance of the order of 10⁻¹ Ω-cm or even greater.

As used herein, the term transparent refers to any material or device which allows transmission, to some extent, of electromagnetic radiation, in particular but not exclusively visible light. Various aspects of the present invention have particular application to transparent material located adjacent to one or more pixels of a display device, and allowing transmission of electromagnetic radiation, particularly but not exclusively visible light, from such pixels. Such transparent material, in particular when located adjacent to one or more pixels of a display device, can be translucent, and the term transparent as used herein includes within its scope the term translucent

The transparency of that region of the conductor may be preferably greater than 70%, preferably greater than 80%, at 550 nm wavelength. For the highest performance end of the flat panel display market, a very high transparency at 550 nm may be required. Assuming all of the metal nanoparticles promote an increase in luminous absorption, then the transmissivity would be expected to reduce as metal particles are added to the transparent material. However, given the multiple particle stacking nature of thin film, some of the metal particles will be aligned directly above other metal particles thereby reducing the effective absorption due to a reduced absorption capture cross-section potentially raising the effective luminous transmissivity.

The flat panel displays may be used in laptops, mobile phones, hand-held personal processors and electronic games which require very high optical transmissivity across the luminous waveband. The electrical conductors described herein may be used in such flat panel or other displays. Preferably a transparent region of such conductors is aligned with at least one pixel, and preferably electrical charge transport through the conductor acts to activate or deactivate the or each pixel. The electrical conductors described herein may also be used in solar energy generating sources, such as solar panels.

The conductive particles preferably comprise nanoparticles. These conductive particles are preferably of uniform or non-uniform size, but preferably have a mean size less than 1000 nm. The conductive particles preferably have a mean size less than 100 nm, more preferably less than 20 nm. The conductive particles may have a mean size less than 10 nm.

The ratio of the size of the conductive particles to the size of particles of the transparent material may be preferably equal to or less than 1:1, preferably less than 0.5:1. This may be because the ratio of the metal particle size to the transparent conductor particle size may be an important factor in optimising the electrical and optical performance of the mixed particle film. This may be because equal sized particles will take up a larger volume for the same number of interparticle connections. However if the metal particle may be of a size that permits contact between transparent conductor nearest neighbours and the associated metal particles, then the volume of metal may be reduced over that area for identical particle size and the effect of direct absorption of light may be reduced in the ratio of the volumes. There may be a specific relationship between the size of the metal particle to the transparent conductor on purely geometrical grounds if all surfaces are to touch, which from geometrical and mathematical considerations suggests that the metal particle diameter (assuming a spherical particle) could be of order 0.42 times the diameter of the transparent conductor. This suggests that, for instance, a transparent conducting particle of size 18 nm could be combined with a metal particle size of 7.56 nm.

The transparent material may be preferably selected from the group consisting of a transparent conductive oxide and a transparent polymer such as:
Inorganic transparent conducting oxides [ATO, TO, ITO, FTO, ZnO, SrCu₂O₂, etc.]
Organic [Pedot-PSS, Polyaniline, etc.]
Organically modified ceramics [Metal alkoxides, etc.]

The conductive particles preferably comprise metal particles, more preferably at least one of silver, gold, copper, aluminium, tin, zinc, lead, indium, molybdenum, nickel, platinum and rhodium particles.

The ratio of the number of particles of the transparent material to the number of conductive particles may be preferably substantially uniform throughout the conductor. This can provide a minimum volume for a maximum nearest neighbour contact density for each particle type. It may be possible to construct this packing structure in a manner that permits metal-to-transparent conductor particle contact with or without transparent conductor-to-transparent conductor contact. In order to achieve the maximum charge transfer, a metal particle may be selected that is small enough to reside interstitially between the close-packed transparent conductor particles whilst still contacting each transparent conductor particle, while permitting the transparent conductors also to touch each other. This could provide a means of combining metal and transparent conductor particles in such a manner that maximum conductivity and transmissivity can be achieved in a single coating that would not be achieved from a coating containing only one particle type.

This ratio of the number of particles of transparent material to the number of conductive particles may be preferably equal to or greater than 4:1. If each particle is spherical in shape and of the same diameter then it could be expected that one metal particle would contact 4 transparent particles, thus providing more efficient interaction between particle types.

Within this region, the ratio of the number of particles of transparent material to the number of conductive particles may be preferably locally varied in order to provide sub-regions with different conductivity, optical transmissivity and/or thickness.

Preferably, said region of the conductor has a sheet resistance of less than 800 Ω per square. A mixed ink serves the need to be able to print whole area and patterned transparent conductors that exhibit a sheet resistance of less than 800 Ohms per square with a transparency of at least 85% at 550 nm wavelength (which may be central to the luminous waveband).

Preferably, said region comprises a single layer of transparent material having said conductive particles dispersed within. In attempting to achieve this in a single ink, it may be possible to consider combining a highly conductive particle with a transparent conducting particle to introduce a small number of conduction centres in a p-type semi conducting sea. In order to achieve the maximum charge transfer, it may be necessary to select a metal particle that may be small enough to reside interstitially between the close-packed transparent conductor particles whilst still contacting each and permitting the transparent conductors to touch each other also. This provides a means of combining metal and transparent conductor particles in such a manner that maximum conductivity and transmissivity can be achieved in a single coating that would not be achieved from a coating containing only one particle type.

Preferably, in said region, the conductive particles are located between respective layers of transparent material. The transparent conducting material portion of a multilayer can be continuous whereas a metal layer portion of the multilayer can be deposited in a selective fashion so as to promote the equivalent of higher conductivity links within a continuous sea of transparent conducting material but permitting the actual pixel areas to remain higher in luminous transmissivity.

If the luminous transmissivity is reduced by some factor, then it may be possible to construct a trilayer (though it could be binary or higher) transparent electrode using, for instance, drop-on-demand ink jet printing that comprises the following layer sequences:
TCO/Metal/TCO
TCO/Metal/TCO/Metal/TCO

The resulting resistance of a three-layer transparent conducting material only structure may be of the order of 6,600 Ohms, whereas the equivalent resistance of this trilayer vertically stacked structure may be of the order of 900 Ohms. The conductivity of this sort of trilayer is therefore considerably greater than three layers of transparent conducting material only.

Said region preferably further comprises translucent spheres embedded within the transparent material.

Preferably, at least one conductive track provides a source or sink for electrical charge transport to and from said region. The continuous nature of a track surrounding a window provides a means of achieving very high conductivity to provide a source or sink for electrical charge transport into and out of the transparent conducting material that may be deposited in each window. By using particulate or molten droplet metal, the film thickness may be the same or increased relative to an otherwise equivalent transparent conductor for the same geometric area, but with the differing thickness metal, the resulting reduction in resistance may be by a factor of the order of 136 (same film thickness) and 408 (increased thickness), providing means for limiting the voltage drop along conductor length.

The track may be preferably of lower transparency than said region at 550 nm wavelength since it has the required conductivity. The transparent conductor used to provide the conductive window contact can deliberately possess a lower electrical conductivity since the length over which the electronic charge must travel may be very much reduced. This opens up the potential of providing a much higher optical transparency as a result of the lower density of charge carriers since according to electromagnetic theory; high conductivity and high optical transmissivity are mutually exclusive because photons are strongly absorbed by the high density of charge carriers that promote electrical conductivity.

The track preferably has a width equal to or less than 50 microns. It may be necessary to strike a balance between the conductivity of the track and its visibility. A track of 3 mm thickness may be sufficient for a large area flat panel display, but for many applications, such as high information content, high resolution hand-held displays, a track of 50 microns or less may be necessary in order to enable the information to be efficiently seen. In the case of use in displays, the track preferably is located in the region of non-transparent, usually black material surrounding pixels, and preferably has a width less than that material so that the tracks cannot be seen by a user.

There may be preferably provided an electronic device comprising at least one electrical conductor as described above. Indeed, numerous applications may benefit from the application of transparent conducting thin films, including
2- and 3-dimensional periodic structures
Electrochromic “Smart” windows: [patterned and whole area]
Electronic blinds and large area shutters
Electro-optic micro shutters: [LCD, ferroelectric, electrochromic]
Electro-optic switches: [organic and inorganic]
Flat panel displays: [Low and high resolution, current and field switched active and passive addressing]
Integrated optical devices: [modulators, detectors, spectrum analysers, converters, spatial light modulators]
Light emitting diodes and lasers: [organic, polymeric, inorganic]
Micro sensors: [discrete devices and arrays for gas sensing]
Non-linear optical devices: [organic and inorganic active waveguides]
Photovoltaic cells and switches: [organic and inorganic]
Touch-sensitive switches: [capacitive]
Transparent antennas
Transparent heaters and ice demisters: [large area and integrated device micro heaters]
Transparent micro heaters

The electronic device may comprise a p-type transparent electrically conductive electrode and an n-type transparent electrically conductive electrode, each preferably comprising a conductor as described above. The production of both n- and p-type conducting transparent electrodes opens up the possibility of creating p-n junctions based on the printing of p-type and n-type materials. This can be achieved either as conventional vertical stacked structures or as a single layer comprising a homogeneous distribution of n- and p-type material in close proximity to create novel electronic structures.

A further aspect of the present invention provides a method of fabricating an electrical device, comprising printing on a substrate an electrical conductor comprising transparent electrically conductive material having dispersed therein electrically conductive particles formed from material having a higher conductivity than the transparent material.

Preferably, a fluid comprising both the electrically conductive particles and the transparent material may be printed on the substrate. Alternatively, a first fluid comprising the transparent material and a second fluid comprising the electrically conductive particles are printed on said substrate. The fluids are preferably printed using respective printheads.

At least one and preferably all of the fluid, the first fluid and the second fluid comprises a surfactant. Such surfactant preferably reduces the surface tension when the fluid, the first fluid, and/or the second fluid is deposited on the substrate. Preferably the surface tension is reduced to less than 100 dynes/cm, preferably less than 50 dynes/cm and preferably to around 30 dynes/cm. The surface tension may even be reduced to less than 30 dynes/cm.

Preferably the or each fluid comprises water and/or a solvent, for instance a glycol ether. Preferably the or each solvent evaporates after deposition of the or each fluid on the substrate. The solvent may be evaporated due to application of heat and/or radiation, preferably laser radiation. Application of such heat and/or radiation may additionally or alternatively melt, sinter, anneal and/or reflow the electrically conductive particles and/or said transparent material. The application of such heat and/or radiation may additionally or alternatively alter the chemical composition of said electrically conductive particles and/or said transparent material.

The first and second fluids may be printed sequentially.

Electrically conductive particles are preferably selectively printed so as to form regions of locally increased density and/or thickness on the substrate, such as conductive contacts or tracks or any other pattern or formation that increases the efficiency of the conductor. It possible to use two independent printheads that are placed back-to-back or are combined in a suitable locating jig such that droplets ejected from each printhead are co-incident on the surface area to be coated. This means that the properties of adjacent segments of the same electrical conductor can be modified so as to achieve local changes in electrical conductivity, optical transmissivity, and thickness.

The transparent material may be printed over previously printed electrically conductive particles.

The electrically conductive particles may be printed over previously printed transparent material. In this way, it may be possible to print directly the required metal type in micro or nanoparticle form as a specific pattern onto the transparent material.

On the other hand, the electrically conductive particles may be deposited directly on to the substrate. It may be also possible to apply the particles directly onto a surface that forms part of a device.

The first and second fluids may alternatively be printed simultaneously.

The printing of the transparent material and the electrically conductive particles may form a printed hybrid, and the method may further comprise annealing the printed hybrid. The manner in which nanoparticles contained in an ink droplet, ejected from a drop-on-demand ink jet printhead, come together on the receiving surface, coupled with the nature of any post-treatment (e.g., laser or rapid thermal annealing) may be of significant importance in producing a high mobility device

The whole structure can be thermally annealed to effect good electrical connectivity and electrical performance between the two materials without impairing the very high optical quality. For instance, the conductivity of the material may be designed to provide good charge mobility but only over a limited distance; that may be to the nearest bus bar.

A further aspect of the present invention provides the use, in the manufacture of an electrical conductor comprising transparent electrically conductive material, of metallic nanoparticles.

The nanoparticles are preferably dispersed within the transparent material to improve conductivity thereof. Nanoparticles are more easily distributed around a material than larger particles, thus improving overall conductivity as long as the nanoparticles are conductive and have means for interacting with other conducting substances.

According to a further aspect of the present invention, there is provided an electrical conductor comprising transparent spheres embedded within transparent electrically conductive material. An approach to creating transparent conductive devices may be to separate the electrical performance from the optical performance by virtue of combining two independent materials that offer the best for both properties whilst still retaining adequate electrical conductivity in the optical material in order to achieve the transparent electrode behaviour.

The mixed nanoparticle ink can include optical micro and sub-micro spheres that are optically clear, such as silica or polyethylene structures. The micro spheres, which could be conducting, semiconducting, or insulating, enhance luminous transmissivity and also influence the geometrical dispersion of the emitted light, as well as promote improved durability and wear resistance. The spheres preferably have a mean diameter of less than 10 microns. The spherical form aids in packing of the particles and the small size aids in the efficient distribution of the particles and opens up several avenues of application of the spheres onto a substrate or into the transparent material.

The conductor preferably comprises, between the transparent electrically conductive material and a substrate, a layer of transparent material to which the spheres are secured. It may be possible for the nano or micro spheres to be added to a printed transparent conductor before it has been dried so that the spheres are retained in the material. It may be also possible for the nano or micro spheres to be added to a surface to provide a distribution of dried spheres that would then be embedded by printing a second transparent conductor ink, such as a metal alkoxide sol or intrinsically conducting polymer, that would coat around the spheres provide mechanical binding and electrical transport.

Preferably, the spheres and the layer of transparent material are substantially optically matched. The in-fill material can be used to provide optical matching to the substrate media in order to minimise reflection losses. Once this filling has been completely dried than the whole area coating of the transparent conducting material can be completed

The transparent material may be preferably selected from the group consisting of a transparent conductive oxide and a transparent polymer, for example:
Inorganic transparent conducting oxides [ATO, TO, ITO, FTO, ZnO, SrCu₂O₂, etc.]
Organic [Pedot-PSS, Polyaniline, etc.]
Organically modified ceramics [Metal alkoxides, etc.]

The spheres are preferably formed from one of conductive, semiconductive or insulating material.

A further aspect of the present invention provides a method of fabricating an electrical device, comprising printing on a substrate an electrical conductor comprising transparent electrically conductive material and transparent spheres.

Preferably, a first fluid comprising the transparent material and a second fluid comprising the spheres are printed on said substrate. The nano or micro spheres may be added to a printed transparent conductor before it has been dried so that the spheres are retained in the material. The nano or micro spheres may be added to a surface to provide a distribution of dried spheres that would then be embedded by printing a second transparent conductor ink, such as a metal alkoxide sol or intrinsically conducting polymer, that would coat around the spheres provide mechanical binding and electrical transport.

The fluids are preferably deposited using respective printheads.

The first and second fluids may be deposited sequentially. As mentioned above, the nano or micro spheres may be added to a surface to provide a distribution of dried spheres that would then be embedded by printing a second transparent conductor ink, such as a metal alkoxide sol or intrinsically conducting polymer, that would coat around the spheres provide mechanical binding and electrical transport. Sequential deposition may be therefore required.

The transparent electrically conductive material may be initially printed on to the substrate, and the spheres may be subsequently deposited on the transparent material before complete drying thereof so that the spheres become embedded within the transparent material. This provides mechanical binding and electrical transport, as required.

A second transparent material may be initially deposited on to the substrate, the spheres being deposited on that transparent material before complete drying thereof so that the spheres are retained by that transparent material, the transparent electrically conductive material being subsequently deposited between the retained spheres. This can provide another method of ensuring that the particles are properly embedded in the transparent material for the reasons outlined above.

The second transparent material may be cured using electromagnetic radiation prior to the deposition of the transparent electrically conductive material. This can help to keep the transparent materials separate and the particles embedded in order to retain desired properties of the respective materials.

The printing of the transparent material and spheres may form a printed hybrid, the method preferably further comprising annealing the printed hybrid. The whole structure may be thermally annealed to effect good electrical connectivity and electrical performance between the two materials without impairing the very high optical quality.

A further aspect of the present invention provides the use, in the manufacture of an electrical conductor comprising transparent electrically conductive material, of transparent spheres. The spheres may be embedded within the transparent material to improve the photon transmissivity of the conductor.

The spheres may be embedded within the transparent material to improve durability and/or wear of the conductor.

A further aspect of the invention provides an electrical conductor comprising transparent electrically conductive material and at least one conductive track formed from electrically conductive particles and providing a source or sink for electrical charge transport to and from the transparent material.

The continuous nature of the track provides a means of achieving very high conductivity to provide a source or sink for electrical charge transport into and out of the transparent conducting material, which may be deposited in a window at least partially surrounded by the track.

Preferably the electrically conductive particles are nanoparticles.

The nanoparticles are preferably of uniform or non-uniform size, and preferably have a mean size, preferably a mean maximum cross-sectional dimension, less than 1000 nm. The nanoparticles more preferably have a mean size, preferably a mean maximum cross-sectional dimension, less than 100 nm, preferably less than 20 nm. The small size of the nanoparticles enables them to be applied to a substrate, for instance via an ink from a printhead, and for them to be more easily distributed in a thin film over the substrate or other surface. Furthermore, given the use of nanotectics, a focused laser that permits impact dynamic and spreading/coalescence equilibrium to be achieved can be employed to reflow the printed metal nanoparticles. This opens up the possibility of printing a wide variety of such metal nanoparticles on to temperature stable and temperature sensitive substrate media and of employing a much wider range of metal elements and alloys using particles in the range 1 to 10 nm.

Preferably the electrical conductor is formed on a substrate, with the transparent electrically conductive material and/or a fluid comprising the electrically conductive particles being selectively deposited on the substrate using a drop-on-demand printing technique. This can be a very precise way of depositing the fluid where it may be required in order to print desired patterns.

Since the conducting line width may be so large compared to the printed feature resolution, it may be possible to print directly the required metal type in micro or nanoparticle form as a specific pattern that includes an integral well within a continuous conductor. The printed metal track with discrete via-holes or contact windows in it may then be thermally treated using a laser or rapid thermal process in a controlled atmosphere so as to create an amorphous or other preferred crystalline state whilst retaining the purity of the original metal particles. The width of the walls parallel to the direction of the conductive track that may be used to address individual display pixels may be printed at a width that cannot be discerned by eye at the correct viewing distance for the display device to be produced. The continuous nature of the metal surrounding each window provides a means of achieving very high conductivity to provide a source or sink for electrical charge transport into and out of the transparent conducting material that may be to be deposited in each window. In the case of use in displays, the track preferably is located in the region of non-transparent, usually black material surrounding pixels, and preferably has a width less than that material so that the tracks cannot be seen by a user.

The manner in which nanoparticles contained in an ink droplet, ejected from a drop-on-demand ink jet printhead, come together on the receiving surface, for instance the or a substrate, coupled with the nature of any post-treatment (e.g., laser or rapid thermal annealing) may be of significant importance in producing a high mobility device.

A transparent conducting window may be formed directly in the reflowed/annealed/recrystallised metal printed conductor or feature in a manner that is dependent upon the scale of the feature to be produced. For example, a 3 mm wide conductor and a 50 micron wide conductor may provide a transparent conducting window adjacent to a display pixel as part of an addressing line in a large area flat panel display for the 3 mm wide conductor or a high information content high resolution hand-held display for the 50 micron wide conductor.

Preferably the electrically conductive particles are deposited on the or a substrate and are treated after deposition so as to increase the electrical conductivity of the at least one track.

Preferably the deposited electrically conductive particles are caused to form the at least one conductive track, the at least one conductive track being a continuous, discrete, conductive track.

Preferably the track is formed by at least one of sintering, melting, and annealing, preferably of at least some of the electrically conductive particles. Given the use of nanotectics, a focused laser, located adjacent to the point of droplet impact or at some controlled distance from the point of droplet impact (including the use of laser scanning and spatial light modulation) that permits impact dynamic and spreading/coalescence equilibrium to be achieved, can be employed to reflow the printed metal nanoparticles.

The electrical conductor may be for use in a display device, and the at least one conductive track may be of such a size as to not be visible to a user during operation of the display device.

Preferably the at least one conductive track has a width equal to or less than 100 microns and preferably equal to or less than 50 microns.

The electrical conductor may be for use in a display device, and the transparent electrically conductive material may be adapted to be aligned with a pixel of the display device and preferably the electrical conductor is adapted to act as a source or sink of electrical charge so as to activate or deactivate the pixel.

The at least one conductive track may define a window, and preferably the transparent electrically conductive material is deposited within the window using the technique of drop-on-demand printing.

The continuous nature of the electrically conductive material, preferably metal, surrounding each window can provide a means of achieving very high conductivity to provide a source or sink for electrical charge transport into and out of the transparent conducting material.

In a further aspect there is provided an electrical conductor comprising at least one conductive track formed on a substrate and transparent electrically conductive material, the at least one conductive track providing a source or sink for electrical charge transport to and from the transparent material, wherein the at least one conductive track defines a window at least partially surrounded by the track and the transparent material is deposited within the window using the technique of drop-on-demand printing.

Preferably the at least one conducting track is formed on the substrate using a lithographic printing technique. A hybridisation of offset lithographic and dropon-demand ink jet printing may be used to produce the transparent conducting element required.

The track may be formed on the substrate using a plating technique. The offset lithographic process may use a 3 micron thick electroless plating insulating seed layer. The printed seed layer may be immersed in an electroless plating bath and a thin thickness of copper metal may plated on to the seed layer. The copper thickness may modify the actual bus bar and tram line spacing by virtue of the fact that the electroless plating may be deposited on all exposed surfaces of the seed layer, hence, for example, a 10 micron wide seeding layer track may increase to 12 micron and the adjoining transparent window width, located between the opaque metal tram lines, may be reduced to 98 microns for a 1 micron electroless plated copper thickness. The resulting electroless plated copper film may possess a low transparent window bus bar resistance.

Preferably the at least one conducting track provides a containment well for the transparent material. Two conductors may be spaced, say, 1 mm apart and may be connected at the ends to form a rectangular containment well. Electrically the connection nodes may be such that the two separated conductors behave as if they were a single conductor of double width and the same thickness, improving the effective conductivity.

Preferably a single layer of transparent material is deposited within the window.

A rectangular well may be filled with a layer of transparent conducting material which is electrically connected to the conductive walls of the well. In this case the sheet resistance may be the same as otherwise because the connecting conductive links bridging the two long conductors effectively short-circuit the material that may be deposited between them. This can ensure that charge generated in the centre of the well can reach the conductor and be swept away thereby acting as a continuous transparent conducting rectangular window.

Alternatively a plurality of layers of transparent material may be deposited within the window.

Preferably the track is formed from electrically conductive material which, when oxidised, has increased transparency, and the transparent electrically conductive material is formed by selectively oxidising portions of the track.

Thus, there may be used a single printing ink that comprises a metal particle that when oxidised becomes a highly transparent but electrically conducting material.

That feature is particularly important and is provided independently. Accordingly, in a further aspect there is provided an electrical conductor comprising at least one conductive track formed on a substrate and transparent electrically conductive material, the track providing a source or sink for electrical charge transport to and from the transparent material and the transparent electrically conductive material being formed by selective oxidation of at least one portion of the track.

Preferably the selective oxidation comprises ultra-violet oxidation. The selective oxidation may be carried out by application of laser radiation or TFD radiation, preferably in an oxidising environment.

A self-assembled non-wetting monolayer can be deposited for example using drop-on-demand ink jet printing, and be patterned in a step-and-repeat manner using an integrated UV Lamp patterning or Laser digital pattern transfer to create wetting and non-wetting regions on the surface. A second transparent conductor ink may then be delivered to the surface using ink jet printing that segregates to the wetting lands to produce the required transparent conductor layout, with the patterning defining monolayer material being removed using chemical means.

Preferably the transparent material comprises at least one of a transparent conductive oxide and a transparent polymer.

The transparent material may be preferably selected from the group consisting of a transparent conductive oxide and a transparent polymer, for example;
Inorganic transparent conducting oxides [ATO, TO, ITO, FTO, ZnO, SrCu₂O₂, etc.]
Organic [Pedot-PSS, Polyaniline, etc.]
Organically modified ceramics [Metal alkoxides, etc.]

Preferably the transparent electrically conducting material has dispersed therein further electrically conductive particles, the further electrically conductive particles having a higher conductivity than the transparent material.

The electrically conductive particles, which may be nanoparticles, are preferably metallic, and more preferably at least one of silver, gold, copper, aluminium, tin, zinc, lead, indium, molybdenum, nickel, platinum and rhodium nanoparticles. These are high conductivity metals that could be considered for the production of conductive windows, wells, and constraining features that can be filled with an inorganic transparent conducting oxide (TCO) or an organic transparent conductor (OTC) whether doped, defect-induced, or intrinsically conducting. These conductive particles are preferably of uniform or non-uniform size, but preferably have a mean size less than 1000 nm. This opens up the possibility of printing a wide variety of such metal nanoparticles on to temperature stable and temperature sensitive substrate media and to employing a much wider range of metal elements and alloys using particles in the range 1 to 10 nm. Hence, the conductive particles preferably have a mean size less than 100 nm, more preferably less than 20 nm.

Preferably at least part of the conductor has a transparency greater than 70%, preferably greater than 80%, at 550 nm wavelength. For the highest performance end of the flat panel display market a very high transparency at 550 nm may be desirable.

Preferably the at least one conductive track at least partially surrounds the transparent electrically conductive material.

The at least one track and the transparent material may partially overlap. Overlapping the track and the transparent material may aid the efficiency of the source or sink for electrical charge into and out of the transparent material. The at least one track may directly contact the transparent material.

Preferably further, electrically conductive material is disposed between the at least one track and the transparent material. The quality of the metal contact surrounding each contact window well may be enhanced by printing the edge of the well using a different ink, such as a metal alloy, cermet, or mixed particle ink, that provides controlled wall wetting, better electrical contact matching and lower contact resistance, and provides a means of controlling the intermetallic behaviour and mechanical strength at the interface between the metal conductor, the contact window edge, and the transparent conducting material that may be deposited within it.

It is possible to fill a rectangular track well with a transparent conducting material that is electrically connected to the conductive walls of the well. This gives low sheet resistance because the connecting conductive links bridging the two long conductors effectively short-circuit the material that may be deposited between them.

The electrical conductor may be disposed on a transparent substrate. This may be so that the entire structure may be as transparent as possible, while retaining conductivity.

The conductor preferably comprises further transparent material located between the substrate and the transparent electrically conductive material.

The at least one conductive track may be of lower transparency than the transparent material at 550 nm wavelength.

The transparent material may be deposited over the at least one conductive track.

The electrically conductive material may comprise a metal with a lower melting temperature than that of the transparent material. Metals have low resistivity (they are highly conducting) and low melting temperature metal particles are more easily used in nanotechnics. This provides a means of limiting the voltage drop along such a conductor when employed in rigid or flexible large area flat panel displays or photovoltaic cells/panels/sheets. As pure metal electrical resistivity can be achieved in the laser melted or rapid thermally processed (RTP) ink jet patterned features, the resistance of a common conductor geometry fabricated using low melting temperature metal particles will be reduced when compared with the best conventionally deposited transparent conductor resistivity depending on the metal chosen.

Preferably at least one of the conductive track and the transparent electrically conductive material is formed using nanotectics. Given the use of nanotectics, a focused laser that permits impact dynamic and spreading/coalescence equilibrium to be achieved can be employed to reflow the printed metal nanoparticles. This opens up the possibility of printing a wide variety of such metal nanoparticles on to temperature stable and temperature sensitive substrate media and to employing a much wider range of metal elements and alloys using particles in the range 1 to 10 nm.

Preferably the electrically conductive particles are deposited within grooves formed on a substrate, preferably so as to partially fill the grooves. A glass plate which has been coated with a self-assembled monolayer (SAM) may provide a highly non-wetting surface. A laser may be scanned over the plate surface to define a series of grooves in the near surface and plate surface, which are below the detection limit of the eye and form a set of containment trenches. The grooves, which can be produced using other methods, can be in a single direction (x or y) or in orthogonal directions (x and y) where the cross-over points provide connectivity between the both axes. The resulting grooves are filled with fluid which can be achieved using precision spraying or drop-on-demand ink jet printing, where the wetting nature of the groove wall causes the ink to flow into the etched trench leaving the surface free of ink because of the differential nature of the surface energy in the groove and that related to the non-wetting SAM coating on the exposed surface between the grooves. The resulting solidified metal in-fill preferably does not completely fill the groove in order that the transparent conducting coating can flow into the groove and provide a direct connection on to the metallic bus bar.

Preferably the grooves are formed in a coating formed on the substrate. A coating may be more readily adapted to have grooves etched into it, for example.

The grooves may be formed by laser ablation. Laser ablation may selectively remove the coating material thereby producing the required shallow groove in a material that can be electrolytically plated to provide the high conductivity copper bus bar structure whilst still retaining a very high open area that may be devoid of any undesired material.

The at least one track may formed subsequent to the formation of the at least one region of transparent electrically conductive material on the substrate. For example, screen printed metal tracks may be printed onto a transparent conductor to provide a means of providing an electric current to the transparent conductor making use of a low resistance electrical bus bar/conductor that may be not transparent.

Preferably the at least one conductive track is formed in an interdigitated pattern.

In a further aspect there is provided a method of fabricating an electrical conductor, comprising forming on a substrate a region of transparent electrically conductive material and at least one conductive track, the at least one conductive track being formed from electrically conductive particles and providing a source or sink for electrical charge transport to and from the transparent material.

Preferably the electrically conductive particles are nanoparticles. The nanoparticles may have a mean maximum cross-sectional dimension less than 1000 nm.

Preferably the nanoparticles have a mean maximum cross sectional dimension less than 100 nm, preferably less than 20 nm.

The method may further comprise selectively depositing the transparent electrically conductive material and/or a fluid comprising the electrically conductive particles on the substrate using a drop-on-demand printing technique.

The method may also comprise depositing the electrically conductive particles on the substrate and treating the electrically conductive particles after deposition so as to increase the electrical conductivity of the at least one track.

Preferably the method comprises causing the deposited electrically conductive particles to form the at least one conductive track, the at least one conductive track being a continuous, discrete, conductive track.

The track may be formed by at least one of sintering, melting, and annealing.

The electrical conductor may be adapted to be used in a display device, and the at least one conductive track may be of such a size as to not be visible to a user during operation of the display device.

Preferably the at least one conductive track has a width equal to or less than 100 microns and preferably equal to or less than 50 microns.

The method may further comprise aligning the transparent electrically conductive material with a pixel of a display device, and preferably arranging the electrical conductor to act as a source or sink of electrical charge so as to activate or deactivate the pixel.

The method preferably further comprises forming the at least one conductive track so as to define a window, and preferably depositing the transparent electrically conductive material within the window using the technique of drop-on-demand printing.

In a further aspect there is provided a method of fabricating an electrical conductor, comprising selectively forming on a substrate at least one conductive track defining a window at least partially surrounded by the track, and subsequently using the technique of drop-on-demand printing to deposit transparent electrically conductive material within the window, the track providing a source or sink for electrical charge transport to and from the transparent material.

The at least one conducting track may formed on the substrate using a lithographic printing technique or a plating technique.

Preferably the at least one conducting track provides a containment well for the transparent material.

A single layer of transparent material may be deposited within the window. Alternatively a plurality of layers of transparent material are deposited within the window.

The track may be formed from electrically conductive material which, when oxidised, has increased transparency, and the transparent electrically conductive material may be formed by selectively oxidising portions of the track.

That feature is particularly important and so in a further aspect there is provided a method of fabricating an electrical conductor comprising forming on a substrate at least one conductive track and a region of transparent electrically conductive material, the track providing a source or sink for electrical charge transport to and from the transparent material and the region of transparent electrically conductive material being formed by selective oxidation of at least one portion of the track.

Preferably the selective oxidation comprises ultra-violet oxidation.

The selective oxidation may be carried out by application of laser radiation or LED radiation, preferably in an oxidising environment.

The transparent material may comprise at least one of a transparent conductive oxide and a transparent polymer. Preferably the transparent electrically conducting material has dispersed therein further electrically conductive particles, the further electrically conductive particles having a higher conductivity than the transparent material.

The electrically conductive particles may be metallic, preferably at least one of silver, gold, copper, aluminium, tin, zinc, lead, indium, molybdenum, nickel, platinum and rhodium particles.

At least part of the conductor may have a transparency greater than 70%, preferably greater than 80%, at 550 nm wavelength.

The at least one conductive track at least may partially surround the transparent electrically conductive material. The at least one track and the transparent material may partially overlap.

Preferably the at least one track directly contacts the transparent material.

The method preferably further comprise providing further, electrically conductive material between the at least one track and the transparent material.

The substrate may be a transparent substrate, and the method may further comprise providing further transparent material between the substrate and the transparent electrically conductive material.

The at least one conductive track may be of lower transparency than the transparent material at 550 nm wavelength.

The method preferably further comprises depositing the transparent material over the at least one conductive track.

The electrically conductive material may comprise a metal with a lower melting temperature than that of the transparent material.

Preferably at least one of the conductive track and the transparent electrically conductive material is formed using nanotectics.

The electrically conductive particles may be deposited within grooves formed on a substrate, preferably so as to partially fill the grooves. The grooves may be formed in a coating formed on the substrate.

Preferably the grooves are formed by laser ablation.

Preferably the method comprises forming the at least one conductive track in an interdigitated pattern.

Preferably the transparent electrically conductive material is translucent electrically conductive material.

In a further aspect there is provided apparatus for forming an electrical conductor comprising means for depositing transparent electrically conductive material on a substrate, and means for depositing electrically conductive particles on the substrate so as to form at least one conductive track, the conductive track providing a source or sink for electrical charge transport to and from the transparent material.

Preferably the means for depositing the transparent electrically conductive material and/or the means for depositing electrically conductive particles comprises a printhead adapted to carry out a drop-on-demand printing technique.

The apparatus preferably further comprises means for treating the transparent electrically conductive material and/or the electrically conductive particles, preferably after deposition. The treating means may comprise means for at least one of melting, sintering, and annealing. Preferably the treating means comprises a laser, preferably mounted on the or a printhead.

In a further aspect there is provided a display device comprising at least one pixel and an electrical conductor as described herein, wherein the transparent electrically conductive material is aligned with the at least one pixel and preferably the electrical conductor acts as a source or sink of electrical charge so as to activate or deactivate the at least one pixel.

There is also provided a method of fabricating an electrical device, comprising depositing using a drop-on-demand printing technique an electrical conductor comprising transparent electrically conductive material having dispersed therein electrically conductive particles formed from material having a higher conductivity than the transparent material.

Examples of processes of coating and patterning transparent screens which will be discussed further are:
Continuous ink jet printing
Digital off-set lithography
Drop-on-demand ink jet printing
Electrophotographic printing
Electrostatic printing
Flexographic printing
Gravure off-set lithography
Monographic printing
Laser xerographic printing
Magnetographic printing
Soft lithography stamp transfer
Stencilling
Touch transfer (ink nib process)

Existing printed transparent conductors possess a uniform transparency and conductivity over the surface area of the as-etched and post-treated (where necessary) feature. This means that a specific length and cross-sectional profile of transparent conductor will exhibit an electrical resistance dictated by the resistivity of the thin film used in its construction. For specific application of transparent conducting thin films where the whole area does not need to be transparent, such as in the electrical contacting of flat panel display pixels, it is possible to design the contact tracks so as to create a region that is transparent and a region that is of a lower transparency or is opaque but that possesses a higher conductivity. The functionality of the contacted device is dictated only by the transparent window with the other region providing a means of introducing or removing electronic charge.

Further aspects of the invention which relate to an electronic device and method of manufacture thereof are now considered.

Electronic device and method of manufacture thereof.

A further aspect of the invention relates to a device, particularly an electronic device such as a microelectronic device, and to a method of manufacture thereof, and in particular to the design of an inorganic, polymeric or organic microelectronic device.

Of particular interest is the device design and/or the method of manufacture applied to a thin film organic field-effect transistor (O-FET) as used in polymer electronic (Polytronics) and plastic electronics (Plastronic) applications, or to inorganic and hybrid organic-inorganic structures, and in particular to opto-electronic devices, such as photovoltaic cells and photodiodes, and quantum wire devices and interconnections.

The device design and/or method of manufacture have particular application to medical and bioelectronic sensors, particularly active sensors, and actuators, and to point of care disposable electronic analysing systems.

The invention relates in particular to the manufacture of an electronic device using printing technology, particularly inkjet printing technology as described for instance in International (PCI) Patent Publication No. WO 97/48557, in particular and without limitation at pages 7 to 18, International (PCI) Patent Publication No. WO 99/19900, in particular and without limitation at pages 65 to 68, and United Kingdom Patent Application No. 0313617.3 (agent's reference 25456), in particular and without limitation at pages 20 to 48, each in the name of Patterning Technologies Limited, each of which is hereby incorporated by reference.

In light of the placement accuracy limitations associated with current Original Equipment Manufacturer (OEM) printhead technology the present invention provides, in one aspect, alternate device designs that overcome, at least to some degree, the limitations observed.

The need to use containment wells or trenches limits the ability to construct novel device designs as well as the use of alternate materials other than polyimide. In-line drop placement may be used to fill a containing trench.

Use may be made of a hydrophobic-hydrophilic surface feature, based for instance on polyimide, to form a device, such as an organic field-effect transistor in one example, where the contacts, for instance metal polymer contacts, are deposited using ink jet printing.

In one aspect of the invention there is provided a method of forming an electronic device comprising arranging a surface such that deposition material deposited on a receiving portion of the surface will flow to a desired portion of the surface.

Thus improved control over the distribution of the deposition material is provided.

Preferably, the method comprises using the technique of drop on demand printing to deposit at least one droplet of deposition material.

The deposition material may be deposited on the receiving portion in such a way that a predetermined coverage of the desired portion by the deposition material is obtained.

Preferably, the step of arranging the surface comprises forming a surface pattern.

Preferably, the receiving portion comprises a reservoir for the deposition material, and preferably the reservoir comprises a portion of the surface having a desired wetting property arranged so as to control flow of deposition material from the reservoir.

The receiving portion may be separate from the desired portion, and preferably is remote from the desired portion. By making the receiving portion remote from the desired portion, the coverage of the desired portion by deposition material may be independent of any deleterious effects due to impact of the deposition material on the receiving portion. In particular, the coverage of the desired portion may be unaffected by any splatter of deposition material following impact of the deposition material on the receiving portion, or from washover of impact waves. Thus the coverage of the desired portion with deposition material may be more reliably controlled and may be more uniform than otherwise.

The desired portion may comprise an active region of the electronic device to be formed, and such active region may be a region where current flows and/or where voltage is applied when the device is in use.

The method may further comprise arranging the surface so that deposition material deposited on one or each of a plurality of receiving portions of the surface will flow to a desired portion of the surface, and preferably will flow to a plurality of desired portions of the surface.

The method may also comprise arranging the surface so that the receiving portion is at least as large as the resolution with which the deposition material can be deposited on the surface by apparatus used to put the method into effect.

Preferably the step of arranging the surface comprises arranging the surface so that the deposition material deposited on the surface will flow by way of surface tension and/or interfacial energy driven transport and/or wetting induced forced flow and/or the Marangoni effect

Preferably deposition material deposited on the surface will flow by way of surface tension and/or interfacial energy driven transport and/or wetting induced forced flow and/or the Marangoni effect.

In a further aspect, there is provided a method of forming an electronic device, comprising arranging a surface and/or selecting deposition material such that the deposition material when deposited on the surface will flow to a desired portion of the surface by way of surface tension and/or interfacial energy driven transport and/or wetting induced forced flow and/or the Marangoni effect.

Preferably the method further comprises using the technique of drop on demand printing to deposit at least one droplet of deposition material.

Preferably the step of arranging the surface comprises providing a selected portion of the surface with a desired wetting property, preferably by changing the wetting property of the selected portion of the surface.

This feature is particularly important and so in a further aspect there is provided a method of forming an electronic device, comprising providing a selected portion of a surface with a desired wetting property and depositing deposition material on the surface, so that the distribution of the deposition material on the surface is dependent upon the wetting property of the selected portion.

Preferably the deposition material is deposited using the technique of drop on demand printing.

Variation of the wetting property over at least part of the selected portion may be provided and preferably such variation is a continuous variation.

There may also be provided a discontinuous variation of the wetting property between at least part of the selected portion and at least one adjacent portion of the surface.

Preferably a difference in the or a wetting property between the selected portion of the surface and a further portion of the surface causes containment of the deposition material, and preferably causes containment of the deposition material within at least part of the selected portion or within at least part of the further portion.

The method may further comprise coating the surface.

Preferably the step of coating the surface comprises coating the surface with a layer having a different wetting property from the surface, and preferably the layer comprises a non-wetting layer and/or comprises a monolayer and/or comprises a self-assembled layer.

The method may also comprise applying radiation to the surface and/or to the or a layer on the surface, preferably so as to change the or a wetting property.

The radiation may comprise electromagnetic radiation, preferably ultraviolet radiation. In particular, the radiation may comprise laser radiation.

The laser radiation may be applied using an excimer laser.

The surface and/or the or a layer on the surface may be treated by laser ablation and/or by corona discharge, preferably so as to change the or a wetting property.

Preferably, the step of arranging the surface comprises providing a temperature variation across at least part of the surface, and preferably that temperature variation causes flow of the deposition material across at least part of the surface.

Preferably, the method further comprises heating or cooling the deposition material and/or at least part of the device, preferably so as to control flow of the deposition material.

At least one dimension of the desired portion and/or the surface pattern and/or the selected portion may be less than one micron and/or may be of the order of the wavelength of ultra-violet light.

Flowing fluid may be applied to the deposition material to assist the flow of the deposition material over the surface, and preferably the flowing fluid comprises a gas jet shower.

Thus flow of the deposition material into a region of the surface which would otherwise be restricted by geometrical effects and/or surface tension effects may be obtained.

The flowing fluid may be heated, and may in particular be selectively heated, for instance in order to influence the rheology of the deposition material and/or the flowing fluid, in particular during the flow process of the deposition material over the surface. In the case of a gas jet shower, the gas may be selectively heated.

The deposition material may be deposited on the receiving portion using at least one of ink jet printing, an OEM printhead, high resolution spraying, and liquid continuous jet streaming, preferably liquid continuous jet streaming defined by a fixed duration actuating pulse.

The electronic device may comprise at least one of a transistor, a resistor, a conductor, a diode, a capacitor, an inductor, a surface coil, a josephson junction, an organic, inorganic or hybrid organic-inorganic structure, an opto-electronic device such as a photovoltaic cell or photodiode, a quantum wire device and/or interconnection, or a composite device made from a plurality of such devices, and may comprise in particular a butterfly transistor.

The electronic device may comprise, or be included in, a medical or bioelectronic sensor, particularly an active sensor, an actuator, or a point of care disposable electronic analysing system.

Preferably deposition material is deposited repeatedly and/or further deposition material is deposited, in order to form a layered device.

In a further aspect, there is provided apparatus for forming an electronic device comprising means for arranging a surface such that deposition material deposited on a receiving portion of the surface will flow to a desired portion of the surface, and means for depositing deposition material on a receiving portion of a surface.

The depositing means may be adapted to use the technique of drop on demand printing to deposit at least one droplet of deposition material.

Preferably the arranging means is adapted to select and/or to change a property of the receiving portion.

The depositing means may be adapted to deposit the deposition material on the receiving portion in such a way that a pre-determined coverage of the desired portion by the deposition material is obtained.

The arranging means may be adapted to form a surface pattern on the surface.

Preferably, the receiving portion comprises a reservoir for the deposition material, and preferably the reservoir comprises a portion of the surface having a desired wetting property arranged so as to control flow of deposition material from the reservoir.

The receiving portion may be separate from the desired portion, and may be remote from the desired portion.

Preferably, the desired portion comprises an active region of the electronic device to be formed, and preferably the active region is a region where current flows and/or where voltage is applied when the device is in use.

The arranging means may be adapted to arrange the surface so that deposition material deposited on one or each of a plurality of receiving portions of the surface will flow to a desired portion of the surface, and preferably will flow to a plurality of desired portions of the surface.

The arranging means may also be adapted to arrange the surface so that the receiving portion is at least as large as the resolution with which the deposition material can be deposited on the surface by apparatus used to put the method into effect.

The arranging means is preferably adapted to arrange the surface so that the deposition material deposited on the surface will flow by way of surface tension and/or interfacial energy driven transport and/or wetting induced forced flow.

In a further aspect of the invention there is provided apparatus for forming an electronic device, comprising means for arranging a surface such that deposition material deposited on the surface will flow to a desired portion of the surface by way of surface tension and/or interfacial energy driven transport and/or wetting induced forced flow and/or the Marangoni effect, and means for depositing the deposition material on the surface.

Preferably the depositing means is adapted to deposit at least one droplet of deposition material using the technique of drop on demand printing.

The arranging means may be adapted to change a wetting property of a selected portion of the surface.

In another aspect of the invention, there is provided apparatus for forming an electronic device, comprising arranging means adapted to change a wetting property of a selected portion of the surface so that the distribution of deposition material deposited on the surface is dependent upon the wetting property of the selected portion, and means for depositing deposition material on the surface.

The depositing means may be adapted to deposit at least one droplet of deposition material using the technique of drop on demand printing.

The arranging means may be adapted to provide variation of the wetting property over at least part of the selected portion, and preferably the variation is a continuous variation.

The arranging means may also be adapted to provide discontinuous variation of the wetting property between at least part of the selected portion and at least one adjacent portion of the surface.

Preferably the arranging means is adapted to provide a difference in the or a wetting property between the selected portion of the surface and a further portion of the surface so as to cause containment of the deposition material, and preferably so as to cause containment of the deposition material within at least part of the selected portion or within at least part of the further portion.

The apparatus may also comprise means for coating the surface.

Preferably the coating means is adapted to coat the surface with a layer having a different wetting property from the surface, and preferably is adapted to coat the surface with a non-wetting layer and/or a monolayer and/or a self-assembled layer.

The apparatus may also comprise means for applying radiation to the surface and/or to the or a layer on the surface, preferably so as to change the or a wetting property.

The radiation may comprise electromagnetic radiation, preferably ultraviolet radiation, and in particular the radiation may comprise laser radiation. The apparatus may further comprise an excimer laser.

Preferably the apparatus further comprises means for treating the surface and/or the or a layer on the surface by laser ablation and/or by corona discharge, preferably so as to change the or a wetting property.

Preferably, the apparatus further comprises means for providing a temperature variation across at least part of the surface, and preferably that temperature variation is such as to cause flow of the deposition material across at least part of the surface.

Preferably, the apparatus further comprises means for heating the deposition material and/or at least part of the device, preferably so as to control flow of the deposition material and/or so as to melt the deposition material.

Preferably, the apparatus further comprises means for cooling the deposition material and/or at least part of the device, preferably so as to control flow of the deposition material and/or so as to solidify the deposition material.

Preferably at least one dimension of the desired portion and/or the surface pattern and/or the selected portion is less than one micron and/or is of the order of the wavelength of ultra-violet light.

The apparatus may further comprise means for applying flowing fluid to the deposition material to assist the flow of the deposition material over the surface, and preferably the flowing fluid comprises a gas jet shower.

The application means may be arranged so as to obtain flow of the deposition material into a region of the surface which would otherwise be restricted by geometrical effects and/or surface tension effects.

The apparatus may further comprise means for heating the flowing fluid, preferably for selectively heating the flowing fluid. Such means may be suitable for selectively heating gas in the gas jet shower.

Preferably the deposition means is adapted to deposit deposition material on the receiving portion using at least one of ink jet printing, an OEM printhead, high resolution spraying, and liquid continuous jet streaming, preferably liquid continuous jet streaming defined by a fixed duration actuating pulse.

The electronic device may comprise at least one of a transistor, a resistor, a conductor, a diode, a capacitor, an inductor, a surface coil, a josephson junction, an organic, inorganic or hybrid organic-inorganic structure, an opto-electronic device such as a photovoltaic cell or photodiode, a quantum wire device and/or interconnection, or a composite device made from a plurality of such devices, and may comprise in particular a butterfly transistor.

The electronic device may comprise, or be included in, a medical or bioelectronic sensor, particularly an active sensor, an actuator, or a point of care disposable electronic analysing system.

The deposition means may be adapted to repeatedly deposit deposition material and/or may be adapted to deposit further deposition material, in order to form a layered device.

In a further aspect of the invention there is provided a transistor comprising a gate, a drain contact and a source contact, wherein at least one of the drain contact and the source contact is tapered in at least one of a plane perpendicular to, or a plane parallel to, the direction of current flow between the source contact and the drain contact when the transistor is in operation.

The transistor may comprise multiple gates (lateral and/or vertical geometry), and/or multiple drain contacts and/or multiple source contacts.

Preferably said at least one of the drain contact and the source contact tapers to a minimum thickness in said one or each plane at a point between its ends, and preferably at a point midway between its ends.

In a yet further aspect of the invention there is provided a butterfly shaped transistor, particularly a butterfly organic transistor.

The butterfly shape of drain and source electrodes permits device geometry to be constructed with a minimum in leakage current due to gate-to-drain and/or gate-to-source electrode overlap. This is also true for some alternate geometries that are possible with the method of manufacture as described herein.

For instance, a preferred layout of ink reservoir landing sites promotes line bridging between the sites that results in a continuous contact (for instance, drain and source) edge that still permits transistor action but with minimum gate-to-drain and/or gate-to-source electrode contact overlap. Thus there is provided a device with good on-off current switching ratio characteristics. The finite width of the line relates to issues such as contact resistance and current handling.

In another aspect of the invention there is provided a surface for use in forming an electronic device, arranged so that deposition material deposited on a receiving portion of the surface will flow to a desired portion of the surface.

There is also provided a surface for use in forming an electronic device, arranged so that deposition material deposited on the surface will flow to a desired portion of the surface by way of surface tension and/or interfacial energy driven transport and/or wetting induced forced flow.

In a further aspect of the invention there is provided a surface for use in forming an electronic device, comprising a selected portion having a desired wetting property and arranged so that the distribution of deposition material on the surface is dependent upon the wetting property of the selected portion.

The present invention also relates to the use of surface wetting patterns.

The invention provides in one aspect the creation of a pre-shaped surface pattern that may incorporate an ink reservoir location that serves to feed ink to the whole, or to part, of the pattern by surface tension and/or interfacial energy driven transport.

The pattern may be defined using laser direct ablation, for instance of a specific surface or a surface pre-coated with a layer for instance a non-wetting, preferably self-assembled, monolayer.

For the latter case an excimer laser may define features—that can be sub-micron if desired (ultra violet wavelength of light)—on the surface by ablating particular areas, for instance areas of the non-wetting film.

This can provide abrupt regions of wetting and non-wetting surface that afford containment and/or directional flow for the ink deposited at the reservoir site or sites.

The ink reservoir site or sites are preferably located outside of the active region of the device but are preferably directly connected to the or each active region by the specifics of the wetting/non-wetting pattern.

The or each ink reservoir site or land may be deliberately made large enough to cater for a wide range of cone angle error thereby easing the restriction on the OEM printhead technology (including, for instance high resolution spraying and/or liquid continuous jet streaming for instance defined by a fixed duration actuation pulse).

The specific design of the wetting region pattern may take into account the need to feed ink from more than one location to promote a more uniform liquid pool and concomitant thin film solid coating covering this region.

Thus a Tsunami-like wash-over of ink as droplets hit and spread across a surface can be removed. The ink landing on the reservoir pads can impact and spread within a safe zone before being carried away from the impact site, for instance by wetting induced forced flow.

Preferably, enhanced flow can be achieved by introducing the equivalent of a gas jet shower that can gently force ink to flow into regions limited under non-forced conditions by geometrical and/or surface tension constraints.

Three-dimensional designs, which may be complex and which may include designs requiring enclosed duct filing such as is the case for lab-on-a-chip and micro total analysis systems, can be achieved.

A self-assembled non-wetting monolayer can be deposited for example using drop-on-demand ink jet printing, and be patterned in a step-and-repeat manner using an integrated UV Lamp patterning or Laser digital pattern transfer to create wetting and non-wetting regions on the surface. Ink may then be delivered to the surface. In particular, a transparent conductor ink may then be delivered to the surface using ink jet printing that segregates to the wetting lands to produce a required transparent conductor layout, with the patterning defining monolayer material being removed using chemical means.

A fluid may be deposited within grooves formed on a substrate, preferably so as to partially fill the grooves. A glass plate which has been coated with a self-assembled monolayer (SAM) may provide a highly non-wetting surface. A laser may be scanned over the plate surface to define a series of grooves in the near surface and plate surface, which are below the detection limit of the eye and form a set of containment trenches. The grooves, which can be produced using other methods, can be in a single direction (x or y) or in orthogonal directions (x and y) where the cross-over points provide connectivity between the both axes. The resulting grooves are filled with fluid which can be achieved using precision spraying or drop-on-demand ink jet printing, where the wetting nature of the groove wall causes the ink to flow into the etched trench leaving the surface free of ink because of the differential nature of the surface energy in the groove and that related to the non-wetting SAM coating on the exposed surface between the grooves.

The composition of ink used, for instance transparent conductor ink, can be so modified so as to promote spontaneous localised dewetting due to the nature of the ink viscosity and surface tension, and the substrate surface energy, which can induce differential wetting behaviour via the Marangoni effect promoting or resisting natural wetting behaviour. In this respect, mixed solvent inks are known to affect the wetting of surfaces and, in some cases, to promote controlled patterning of surfaces from an array of discrete dots to interconnected spinoidal dewetting and dendritic patterning.

Fluid flow, in particular flow of the deposition material, can also be achieved by differential thermal energy introduced by a heating means, such as an infrared lamp or laser set-up that causes the local temperature, for instance of the device being formed or the surface on which the deposition material is deposited, to be changed. A suitable change may be of several degrees Celsius.

Such change in temperature can provide a driving force to promote fluid flow without adversely affecting the rheology of the fluid, for instance the deposition material.

Such temperature processing may be modified to alter the temperature at the liquid-solid contact line resulting in a liquid surface tension gradient that either promotes fluid outflow or causes the liquid to retract thereby giving a potential mechanism to promote device trimming of specific properties. The liquid referred to may be the deposition material, and the liquid-solid contact line referred to may be the contact line between the deposition material and the surface on which the deposition material is deposited or to which it flows.

In a further aspect, a selective dewetting mechanism, such as spinoidal dewetting may be used to produce a porous surface, for example a porous contact, as might be expected on a chemitransistor or electronically controlled barrier membrane, suitable, for instance, for micro, nano, and molecular applications.

The deposition material may comprise one or more of a wide variety of inks, including:
Ink suitable for UV curing
Ink suitable for cationic curing
Ink adapted to be subject to a phase change before, during, or following deposition
Solid phase ink
Aqueous-based ink
Organic solvent-based ink
Solutions
Multi-phase ink
Ormocers

Such ink may contain one or more of:
Organic nanoparticles (i.e., pentacene)
Inorganic nanoparticles (i.e., silicon, germanium)
DNA
Carbon nanotubes, fibres, towers, and wires
Molecular species
Rotaxane
Polysilanes and siloles
Polymer(s)
Siloxane
Bioelectronic compounds
Zinc oxide

The ink may comprise, one or more of various modifiers:
Viscosity [Newtonian; shear thinning (pseudo-plastic); shear thickening (dilitant); Bingham]
Surface tension
Electronic conductivity
Light absorbance
Solvent evaporation [humectants]
Dispersants
Surfactants
Elasticity agents
Anti-fungal agents
Chelating agents
pH controllers
Corrosion inhibitors
Defoamers

The deposition material may be dispensed or deposited, preferably to build any or all layers of a specific device, using one or more of:
Pin transfer
Nano pipette
Precision impulse spraying [includes electrostatic and nebuliser methods]
Continuous ink jet
Gravure
Flexographic
Offset
Dip (including roll transfer through a fluidised bed)
Solid source ablation
Solid particle ink jet
Semi-solid continuous strip transfer (i.e., like toothpaste with pressure valve pulsing)
Casting
Vapour transfer condensation
Electrophoresis

Semi-solid and/or solid materials or particles may be steered/deposited on the landing site where they may be thermally melted (local or whole area process) and caused to reflow under the action of the ensuing liquid rheology, surface wetting driving forces, and/or the specific differential surface wetting (liquid)-surface (solid receiving surface) driving energy.

Localised liquid wetting/dewetting may be achieved using various methods. The step of arranging the surface may comprise selectively controlling or patterning the surface, or the receiving surface energy, and the step of arranging the surface may comprise, or may be carried out using, one or more of:
Electrowetting
Surface electronic charge pumping
Roughening
Controlled heterogeneity
Selective imbibition
Surface curvature
Whole area lamp technology [i.e., gas discharge lamp that emulates the properties of an excimer laser but at lower cost]
Solid-state LED or laser in discrete or array format
Selective area deposited SAMs

Preferably the step of arranging the surface comprises treating the surface through chemical exchange with laser energy activated species that reside adjacent to the surface.

Preferably the surface, or a substrate medium located at the surface, comprises one or more of:
Glass
Plastic
Metal
Ceramic
Paper
Crystal wafers
Plant surfaces

The surface, or the substrate media, may be either planar or three-dimensionally shaped, and where appropriate an initial levelling and electrically conditioning layer may be selectively deposited to assist layer adhesion and device performance.

In a further aspect it is possible to promote layer property grading by virtue of changes in the chemistry of the liquid deposited at the landing site or receiving portion of the surface.

In further aspects there is provided alone or in any appropriate combination: a system which is droplet placement error tolerant; laser direct write defined wetting regions; graded wetting zones along contact pattern length to assist fluid levelling; dual zone low resolution printing lands; built in 3 dimensional vias; straight edge alignment; sub-micron pattern resolution; planar interconnections to connect multiple transistors; common or individual transistor design for multiple device circuits; 3 dimensional electrical contact micro via; planar insulator or semiconductor coating leaving an exposed contact pad; all-additive processing; selective area photoexposure which promotes differential wetting leading to liquid coat patterning and modified liquid flow behaviour, for instance for construction of auto-aligned insulating vias; butterfly shaped thin film transistor; staggered organic field effect transistor configuration; dual connections to gate, drain, and source contacts; drain and source contacts constructed as 3 dimensional micro vias; semiconductor filling a gate channel trench only; non-wetting surface between drain-source contact retained for molecular ordering; continuously graded wetting promoting fluid flow and levelling; step graded wetting forcing fluid direction; cross section of contact designed for optimum flow for levelling in device zone; hybrid laser-ink jet printing process; laser direct write deposition; laser direct write ablation of whole area non-wetting coating; liquid levelling behaviour; multiple droplets impacting on ink reservoir contact land; limited wetting by printing more ink on to dried initial coating in order to form 3 dimensional micro via for external contacting and device interconnectivity; determination of optimum shape of wetting land including number of ink reservoir lands to be included within wetting pattern; rheological modification using photoconversion processes to affect viscoelastic damping behaviour; and fluid dispensing onto reservoir land by method other than ink jet printing.

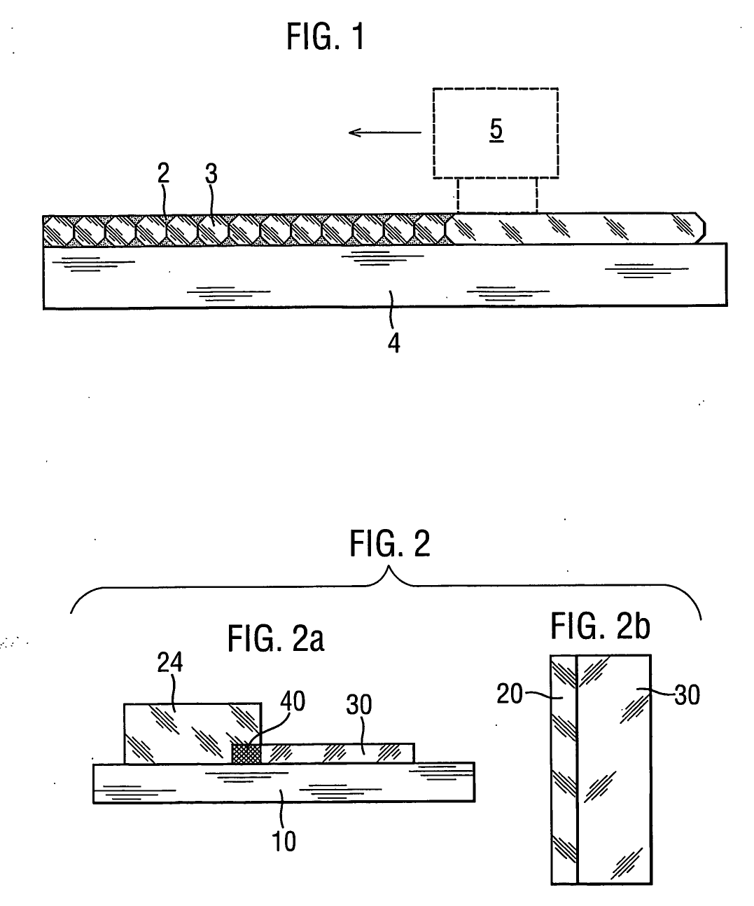

The invention also provides at least one of an electrical conductor, method, apparatus, device, display device and surface substantially as herein described, optionally with reference to one or more of FIGS. 1 to 23 of the accompanying drawings.

Any feature in any one aspect of the invention(s) described anywhere above may be applied to any other aspects of the invention(s), in any appropriate combination.

Method features may be applied to apparatus features and vice versa. Features which are provided independently may be provided dependently and vice versa.

Preferred features of the present invention will now be described, purely by way of example, with reference to the accompanying drawings, in which:

FIG. 1 shows the laser or rapid thermal annealing of an ink printed onto a substrate;

FIG. 2 shows a metal and transparent conductor ink layer;

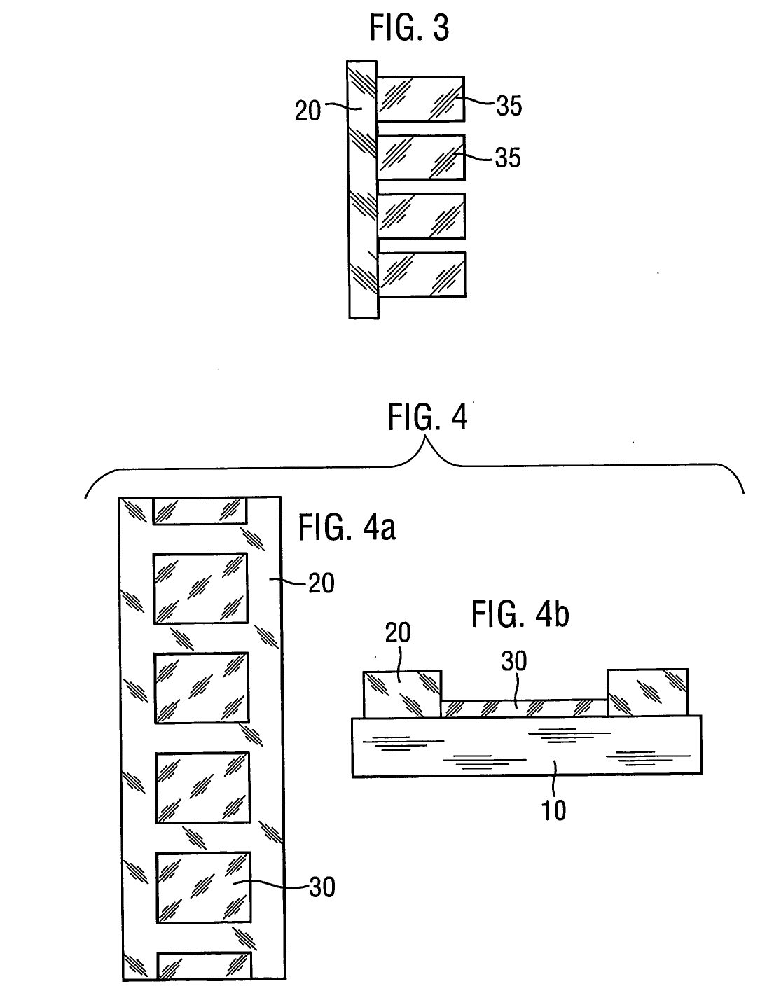

FIG. 3 shows a branched conductor;

FIG. 4 shows a ladder conductor;

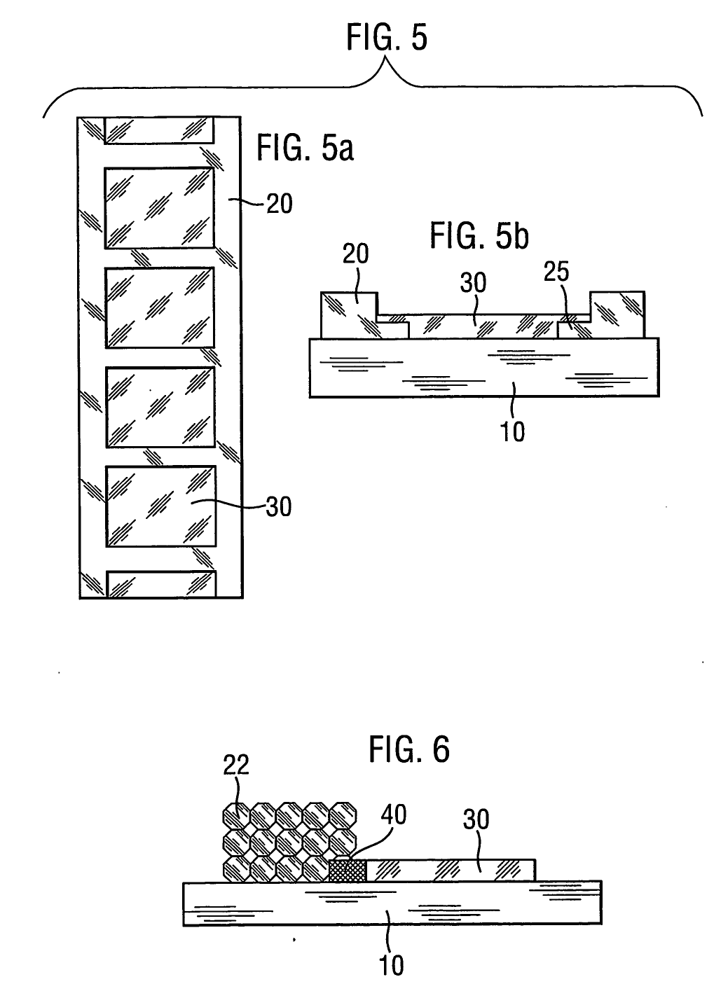

FIG. 5 shows a stepped conductor;

FIG. 6 shows a metal and transparent conductor layer with the metal in ink droplet form;

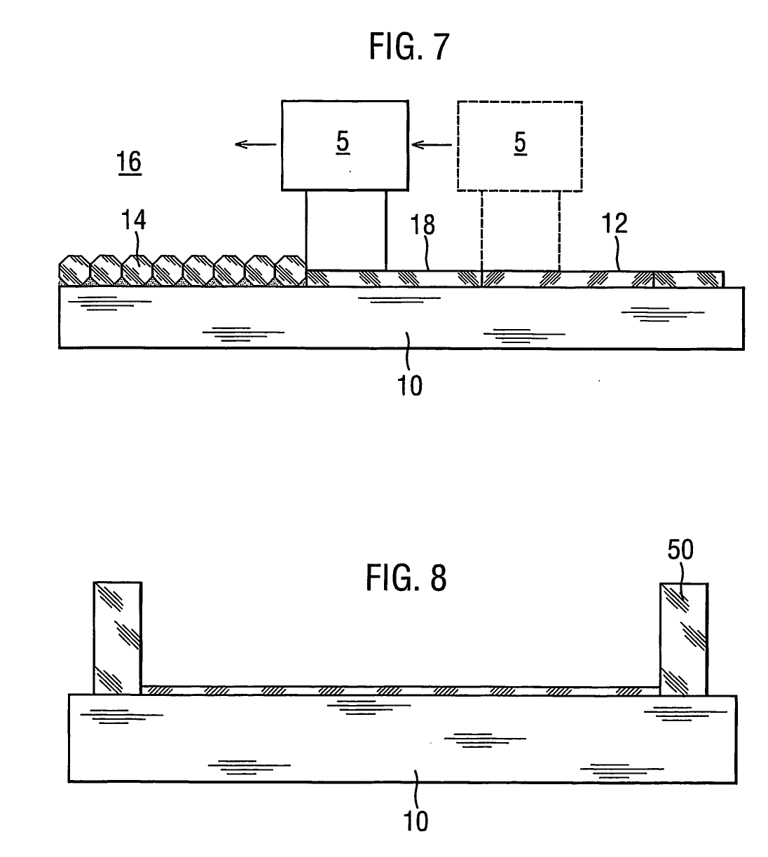

FIG. 7 shows a double laser or rapid thermal annealing process;

FIG. 8 shows a simplified containment channel;

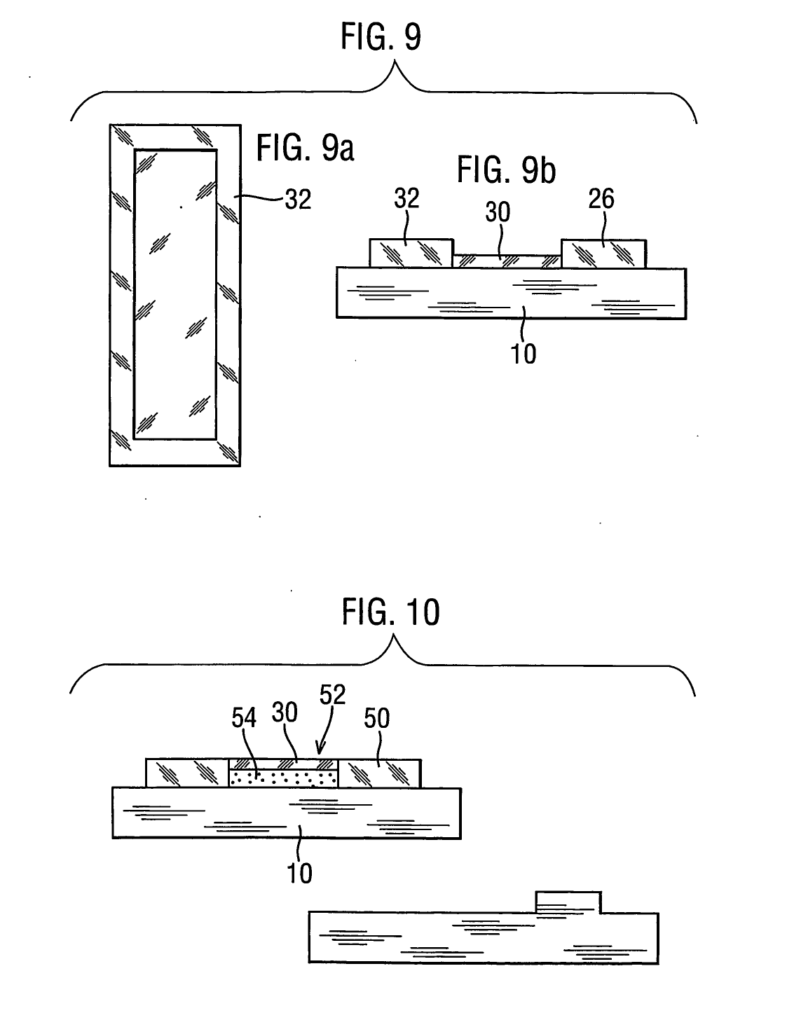

FIG. 9 shows the containment channel with copper electroless plating;

FIG. 10 shows a containment channel with an optically matched polymer layer;

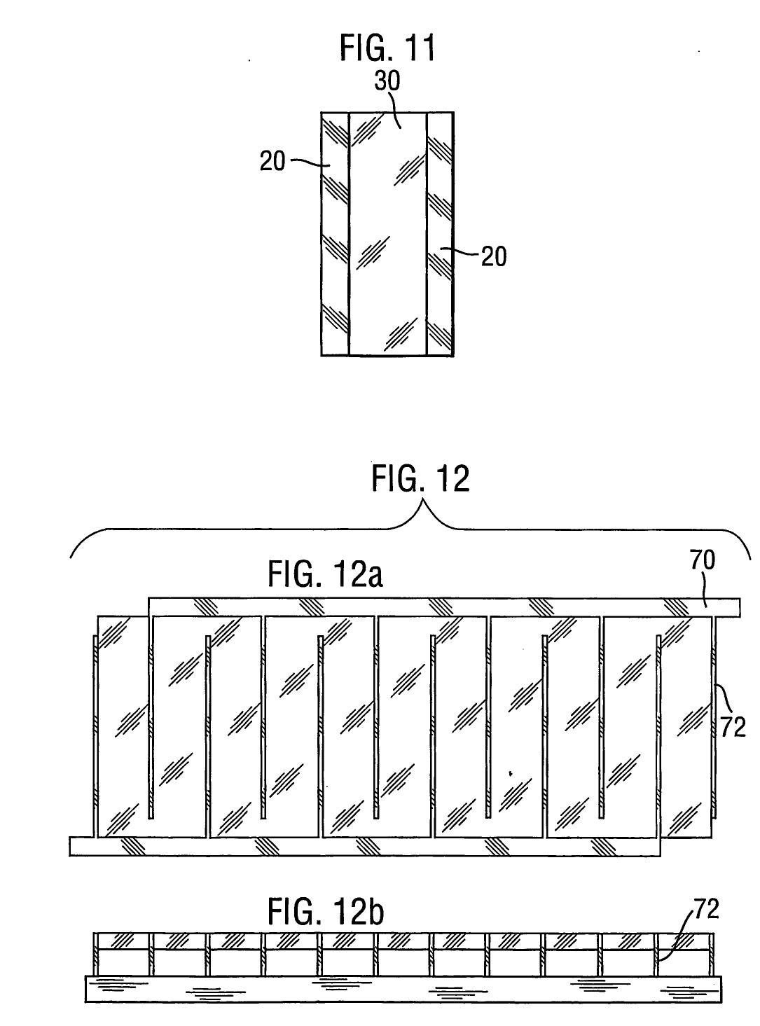

FIG. 11 shows the top view of an isolated containment channel;

FIG. 12 shows an interdigitated containment channel structure;

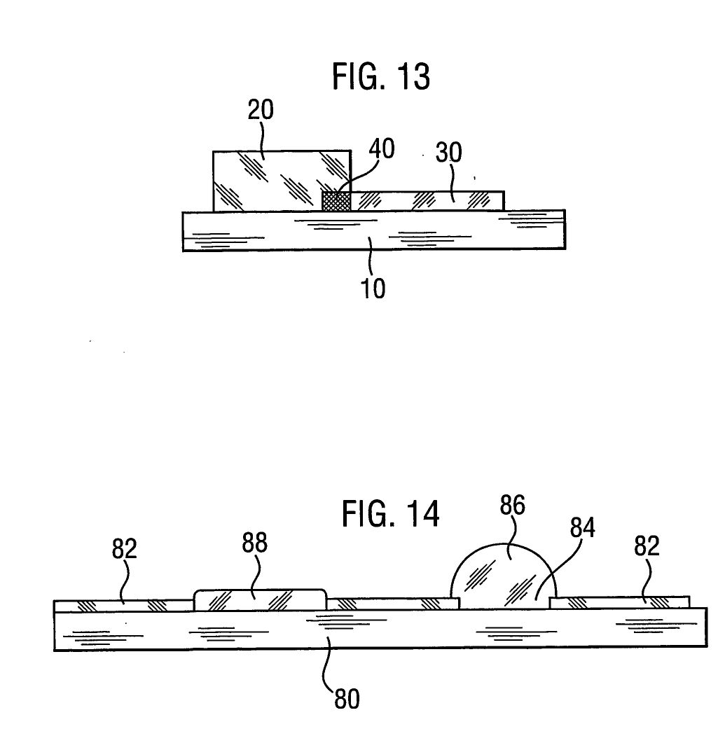

FIG. 13 shows a simple view of a metal and transparent conductor layer with overlap;

FIG. 14 shows etched and filled grooves on a glass plate;

FIG. 15 shows a trilayer conductor containing particles;

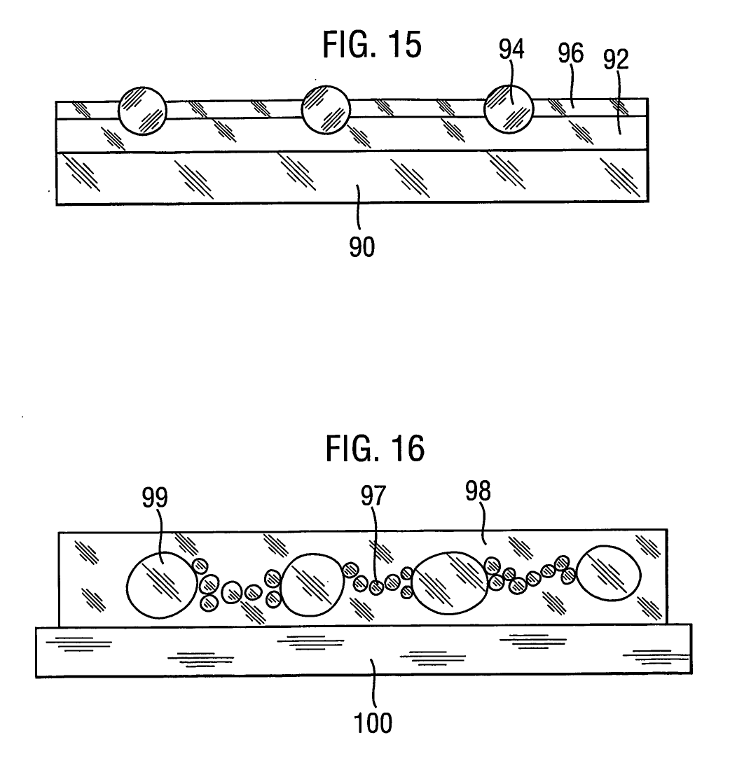

FIG. 16 shows a mixed ink conductor;

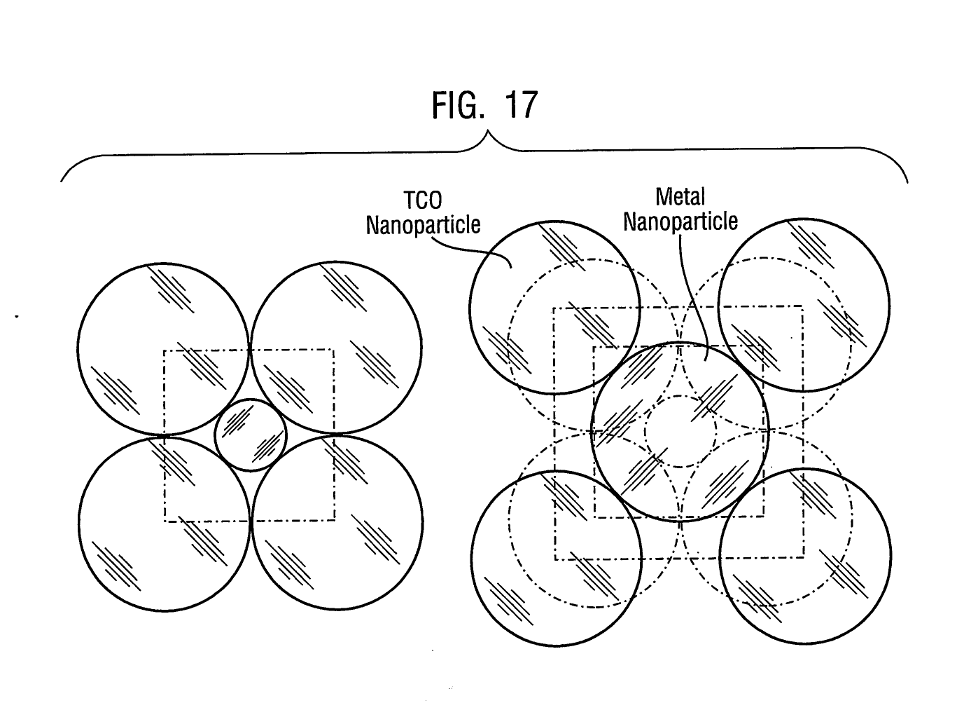

FIG. 17 shows the packing structure of different sizes of metal and transparent particles;

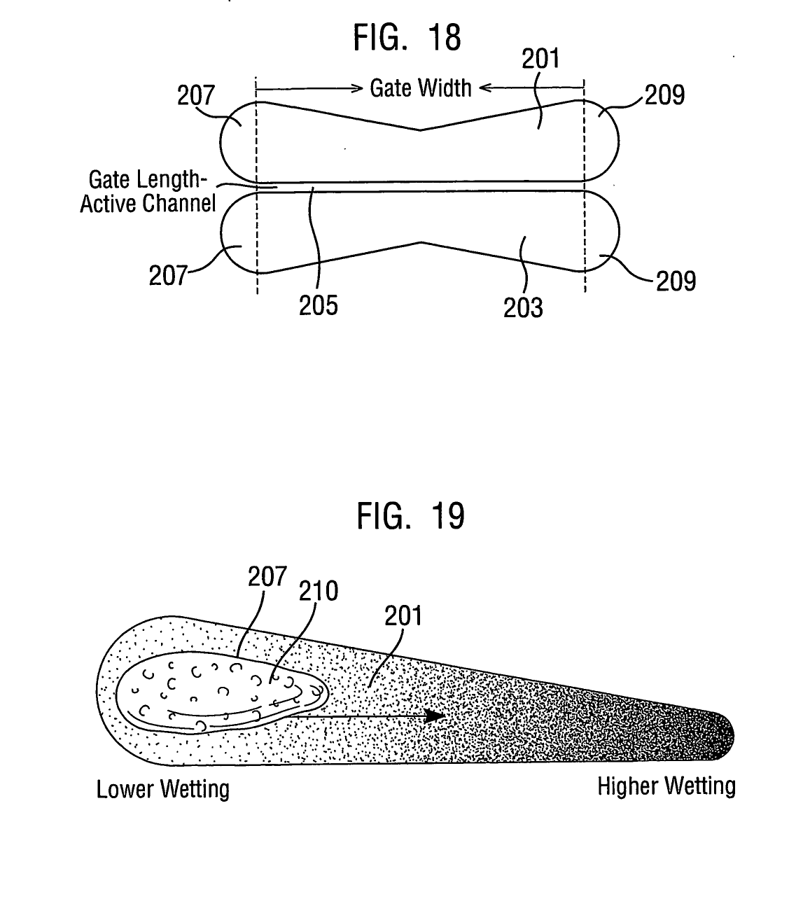

FIG. 18 is an illustration of part of a transistor according to one embodiment, viewed from above;

FIG. 19 is an illustration of fluid dispensing onto a surface to form the transistor of FIG. 18, viewed from above;

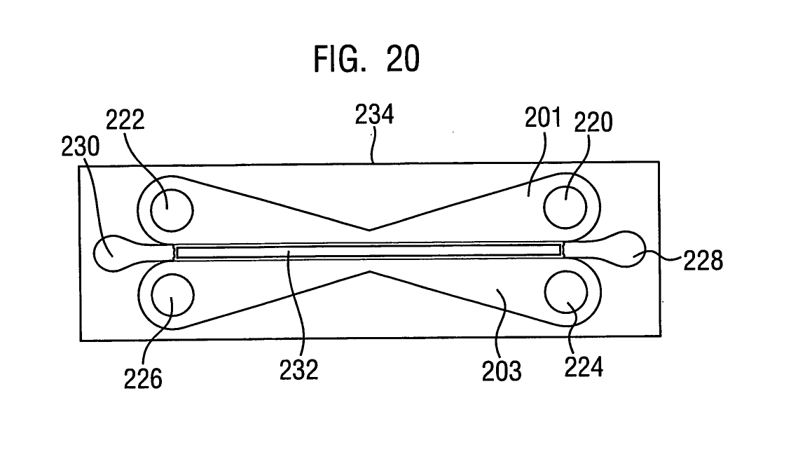

FIG. 20 is an illustration of the transistor of FIG. 18, viewed from above and with the central gate contact shown as partially transparent to show the organic semiconductor;

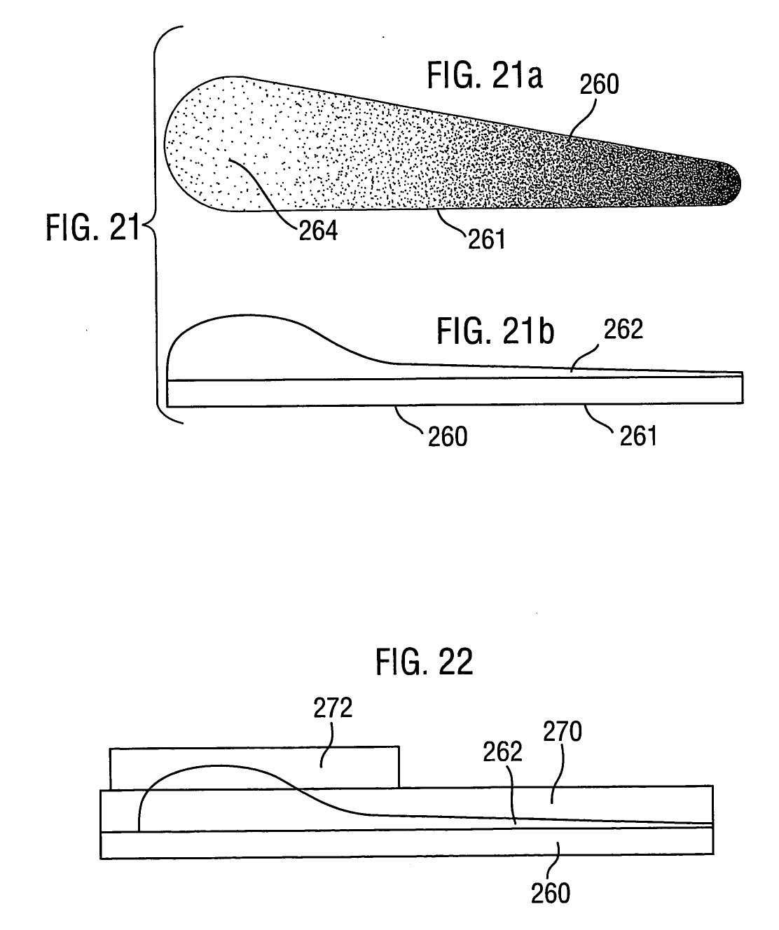

FIG. 21 is an illustration of a surface from above in one embodiment, and deposition material dispersed over the surface, in side view;

FIG. 22 is an illustration of a transistor according to one embodiment, in side view; and

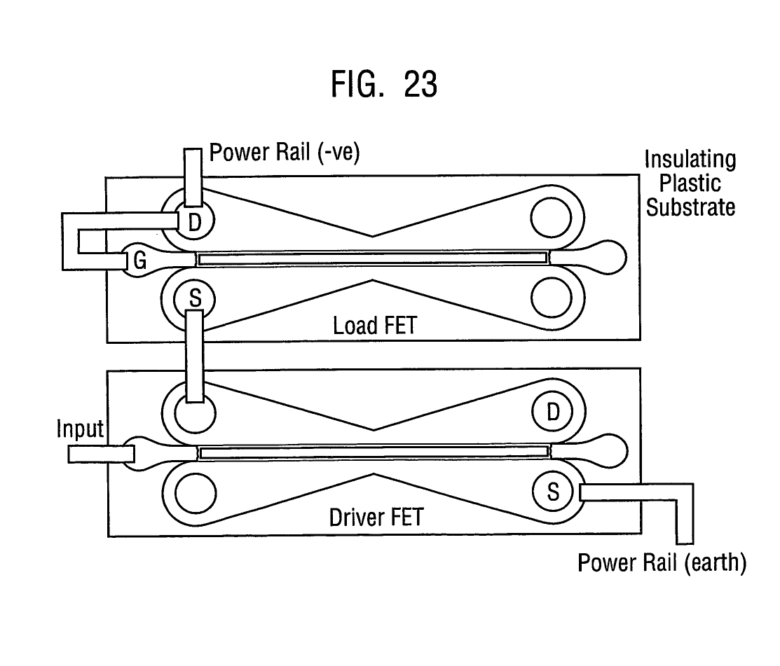

FIG. 23 is an illustration of an Inverter (NOT circuit) constructed using organic field effect transistors, viewed from above.

Preferred embodiments take advantage of the much lower electrical resistivity of such low melting temperature metal particles, as zinc, to provide a low resistance conductor that has, as an integral feature, contact windows into which can be deposited any material including, in this case, a transparent conductor.

The rapid thermal or laser reflowed material can be further smoothed using a hot air/inert gas jet or shower once the initial particle coalescence into a continuous film has been achieved.

FIG. 1 shows an ink 2 containing metal particles 3 which has been printed onto a substrate 4 and then laser annealed using laser 5 or rapid thermally annealed using a high power LED 5, to promote coalescence and interdiffusion for better charge transport.

Other possible low melting temperature metals include but are not limited to:

| | | | Conventional |
|---|---|---|---|
| | | | Melting |
| Metal | Symbol | Resistivity Ω-cm at “X”° C. | Temperature ° C. |
| Indium | In | 8.37 × 10⁻⁶ at 20° C. | 156.6 |
| Lead | Pb | 20.65 × 10⁻⁶ at 20° C. | 327.5 |
| Tin | Sn | 11.0 × 10⁻⁶ at 0° C. | 231.97 |
| Zinc | Zn | 5.92 × 10⁻⁶ at 20° C. | 419.58 |

Given that the pure metal electrical resistivity can be achieved in the laser melted or rapid thermally processed (RTP) ink jet patterned features (some practical limit due to processing conditions will exist but it serves as an illustration of the potential benefit to use the bulk figure) it is expected that the resistance of a common conductor geometry fabricated using low melting temperature metal particles will be reduced by a factor of the order of 9 [Pb] to 33 [Zn] when compared with the best conventionally deposited transparent conductor resistivity (magnetron sputtered: 2×10⁻⁴ Ω-cm) dependent upon the metal chosen. This ratio can be further increased by deliberately making the metal track geometry thicker. For example, a film thickness of zinc relative to the transparent conductor being increased by a factor of 3 results in a reduction in resistance for the same geometric area, but with the thicker metal, of a factor of 99. This provides a means of limiting the voltage drop along such a conductor when employed in rigid or flexible large area flat panel displays or photovoltaic cells/panels/sheets.

The transparent conductor used to provide a conductive window contact can deliberately possess a lower electrical conductivity since the length over which the electronic charge must travel is very much reduced. This opens up the potential of providing a much higher optical transparency as a result of the lower density of charge carriers since according to electromagnetic theory; high conductivity and high optical transmissivity are mutually exclusive because photons are strongly absorbed by the high density of charge carriers that promote electrical conductivity. It is understood that for the highest performance end of the flat panel display market that a transparency at 550 nm of over 90%, preferably over 95%, (i.e. nearly completely transparent, rather than just translucent) is essential.

It is possible to expand the potential of the above conductor by considering the melting behaviour of metallic nanoparticles. It is known that for very small particles of order a few nanometres, it is possible to melt such particles at temperatures much lower than that required to melt a bulk quantity of the same metal due to surface tension effects (large surface-to-volume ratio). This opens up the possibility of achieving the best of metal conductors and transparent conductors using a dual drop-on-demand ink jet or alternate hybrid printing process.

Given the use of nanotectics, it is anticipated that a focused laser, located adjacent to the point of droplet impact or at some controlled distance from the point of droplet impact (including the use of laser scanning and spatial light modulation), which permits impact dynamic and spreading/coalescence equilibrium to be achieved, can be employed to reflow the printed metal nanoparticles. This opens up the possibility of printing a wide variety of such metal nanoparticles onto temperature-stable and temperature-sensitive substrate media and of employing a much wider range of metal elements and alloys using particles in the range 1 to 10 nm. Examples of high conductivity metals that could be used for the production of conductive windows, wells, and constraining features that can be filled with an inorganic transparent conducting oxide (TCO) or an organic transparent conductor (OTC) whether doped, defect-induced, or intrinsically conducting are:

| | | | Conventional |
|---|---|---|---|
| | | | Melting |
| Metal | Symbol | Resistivity Ω-cm at “X”° C. | Temperature ° C. |
| Aluminium | Al | 2.5 × 10⁻⁶ at 0° C. | 660.46 |
| Copper | Cu | 1.55 × 10⁻⁶ at 0° C. | 1,084.88 |
| Gold | Au | 2.05 × 10⁻⁶ at 0° C. | 1,064.43 |
| Molybdenum | Mo | 2.05 × 10⁻⁶ at 0° C. | 2,623.00 |
| Nickel | Ni | 6.2 × 10⁻⁶ at 0° C. | 1,455.00 |
| Platinum | Pt | 9.81 × 10⁻⁶ at 0° C. | 1,769.00 |
| Rhodium | Rh | 4.3 × 10⁻⁶ at 0° C. | 1,963.00 |
| Silver | Ag | 1.47 × 10⁻⁶ at 0° C. | 961.93 |

For example, a particulate or molten droplet of silver is used and the film thickness relative to an otherwise equivalent transparent conductor of electrical-resistivity, ρ, of 2×10⁻⁴ Ohm-cm is left the same or is increased by a factor of 3. The resulting reduction in resistance for the same geometric area and same or higher metal thickness will be by a factor of the order of 136 or 408, respectively, providing an even greater means of limiting the voltage drop along the conductor length.

Whether the above conductor is based on a low or high melting temperature metal, a transparent conducting window can be created directly in the reflowed/annealed/recrystallised metal printed conductor in a manner that is dependent upon the scale of the conductor feature to be produced. For example, 3 mm wide conductors and 50 micron wide conductors serve the purposes of providing transparent conducting windows adjacent to display pixels as part of an addressing line in a large area flat panel display or a high information content high resolution hand-held display, respectively.

FIG. 2 shows metal 20 (for example a micro particle metal 24) and transparent 30 layers on a single substrate 10. The overlapping region 40 provides electrical contact between the two types of layer. FIG. 2a shows a side view and FIG. 2b shows a top view of a “Dual Stripe Conductor Pattern”, which is called such because there is a stripe of each of the two materials. Several other patterns using these materials may be created such as the “Branched” Conductor of FIG. 3 with metal layer 20 and several separated transparent layers 35. The transparent layers may be separated with further conductor layers 20. FIG. 4 show a “Ladder” Conductor with conductor layers 20 on substrate 10. As can be seen from the top view of FIG. 4a, the conducting layers are made up of two parallel lines joined intermittently with further “rungs” of the ladder shape. The space between the rungs is filled with the transparent material 30, as can be seen in the side view in FIG. 4b. FIGS. 5 show the “Stepped” Conductor. The top view of FIG. 5a is similar to the “Ladder” Conductor shape. The difference between the “Ladder” and “Stepped” Conductors is that the conducting layer 20 has a step 25 (seen in FIG. 5b) which is in the transparent layer 30 and provides greater electrical connection between the two materials.

Since the conducting line width is large compared to the printed feature resolution, which is, for instance, 50 microns, it is possible to print directly the required metal type in micro- or nanoparticle form as a specific pattern that includes an integral well within a continuous conductor. The printed metal track with discrete via-holes or contact windows therein is then thermally treated using a laser or rapid thermal process in a controlled atmosphere so as to create an amorphous or other preferred crystalline state whilst retaining the purity of the original metal particles. The width of the walls parallel to the direction of the conductive track that are used to address individual display pixels are printed at a width that cannot be discerned by the eye at the normal viewing distance for the display device. The continuous nature of the metal surrounding each window provides a means of achieving very high conductivity to provide a source or sink for electrical charge transport into and out of the transparent conducting material that is deposited in each contact window well.

Depending on the metal reflow conditions, it is possible to influence the geometry of the contact window well wall so as to eliminate the possibility of poor wall wetting particularly at the base of the wall, which if poorly wet would lead to the classic “mouse hole” effect.

Due to the resolution of the printing process relative to the large feature size it is possible to enhance the quality of the metal contact surrounding each contact window well by printing the edge of the well using a different ink, such as a metal alloy, cermet, or mixed particle ink, which provides controlled well wall wetting, better electrical contact matching and lower contact resistance, and which provides means of controlling the inter-metallic behaviour and mechanical strength at the interface between the metal conductor, the contact window well edge, and the transparent conducting material that is deposited within the well.

The large feature size also makes it possible to consider a wide range of printing methods to produce the required conductor pattern at a reasonable film thickness when dried and laser- or RTP-reflowed/annealed/recrystallised. Examples of suitable printing methods are:
Continuous ink jet printing
Digital plateless off-set lithographic printing
Digital transfer plate off-set lithographic printing
Droplet ejection (not ink jet)
Dry toner printing
Electrophotographic printing
Electrostatic printing
Flexographic printing
Focussed acoustic energy lens less drop-on-demand ink jet printing
Gravure printing
Ionographic printing
Laser xerographic printing
Magnetographic printing
Molten metal drop-on-demand ink jet printing
Piezoelectric drop-on-demand ink jet printing
Pin transfer
Screen printing, especially for thin film transfer
Soft contact stamping
Sublimation printing
Thermal bubble drop-on-demand ink jet printing
Thermo-acoustic drop-on-demand ink jet printing
Wet toner printing

Conductors can be used with one or more inks to achieve the combined electrical conductivity and luminous transmissivity required for a wide range of electro-optical devices and applications.

A hand-held display is one example of the application of above-described transparent conductors with certain limitations and properties.

In a hand-held display, the conducting line width is limited by the resolution of the printing method, which, in this example, is drop-on-demand ink jet printing with a feature limit of 50 microns. It is, therefore, not practical to define a pattern that includes an integral well within a continuous conductor. However, this does not mean that the metal reflow process cannot be used. It merely implies that the manner in which it is used must be one which is applicable to the present example. A suitable process involves a metal with a low melting temperature, such as zinc, which is laser treated to create a reflowed amorphous continuous metallic conductor. Using the same laser shown in FIG. 1 but with a different irradiation pattern as illustrated in FIG. 7 (particularly due to the impact of lens technology with spatial light modulators), it is possible to create the transparent conducting windows 12 by selectively oxidising the amorphous metal 14 in an oxidising environment 16 using the laser or high power LED 5 to assist the metal conversion to conductive oxide 18 or cermet induced via a solid-state or semi-liquid-state reaction process. The resolution of the contact window 12 is determined by the diffraction limit of the laser-lens set-up and by the oxidation edge control, which provides an interface zone that progressively converts the metal to oxide thereby providing a graded interface to promote excellent mechanical and electrical properties.

This process uses a single printing step and a single ink that comprises a metal particle which, when oxidised, becomes a highly transparent but electrically conducting material. Although zinc has been cited for this particular example, low melting temperature metal alloys such as solders can be considered when the resulting oxidised window exhibits cermet-like properties when the metal oxide is not semiconducting.

| | | Conventional |
|---|---|---|
| | Resistivity Ω-cm | Melting |
| Metal | at “X”° C. | Temperature ° C. |
| 50% Lead - 50% Tin Solder | 15.0 × 10⁻⁶ at 20° C. | 216 |
| Magnesium Alloy AZ31B | 9.0 × 10⁻⁶ at 0° C. | 627 |

Certain alloys could comprise materials that are semiconducting and insulating in oxide form resulting in the transparent window exhibiting a conductivity that is defined by the ratio of the cermet-to-semiconducting concentrations.

These two examples show the potential flexibility of the transparent conductor when it is applied onto a substrate. It is also possible to apply the conductor directly onto a surface that itself forms part of a device. An example of this flexibility is the construction of a light-emitting polymer pixel that is switched using a silicon or organic-based field-effect transistor, where the light-emitting polymer pixel has an outer electrode that is required to be electrically conductive and transparent.

Two or more processes may be employed so as to achieve a desired transparent conductor feature. A hybrid process may be the combination of the use of drop-on-demand ink jet printing and digital off-set lithographic printing.

A flat panel display device is a further example of an application of a transparent conductor. In this case, the luminous transmissivity advantageously approaches 100% and the electrical resistance approach zero. Obviously, these perfect conditions are not possible due to practical limitations resulting from the as-deposited and annealed electrical resistivity and the luminous waveband absorption coefficient of the selected transparent conducting material. It is known that changes in the concentration of the carrier of the transparent conducting material influence transmissivity through stronger absorption resulting from the increased charge carriers. The charge mobility associated with the transparent conducting material is therefore the prime target for producing improvements as an increase in mobility does reduce electrical resistance but does not result in a loss in transmission in the visible waveband (400 to 700 nm).

An alternate approach to obtaining high transparency and low electrical resistance is to separate the electrical performance from the optical performance by virtue of combining two independent materials that offer the best for both properties. The same hybrid process as for the hand-held display may be used; that is, the hybridisation of offset lithographic and drop-on-demand ink jet printing, although other production methods are obviously possible, to produce the transparent conducting element desired.

In its simplest form, the offset lithographic printing process is used to deposit a tram line structure that is connected at both ends of the lines so as to create a rectangular structure that is electrically continuous and that has a spacing between the tram lines of between 10 microns (which is the current limit in the direction of print for digital off-set lithography) and several millimetres. FIG. 8 shows an end-on view of a conductive channel with metal tracks 50 on substrate 10.

One example of this form of process creates spacing between the tram lines within the rectangular structure of 100 microns. The spacing between these rectangular structures is 10 microns, providing a printed feature pitch of 130 microns (or 195 tracks per inch). The offset lithographic process in this example uses a 3 micron thick electroless plated insulating seed layer that has a track width of 10 microns. The printed seed layer 26 is immersed in an electroless plating bath and between 0.1 and 1.0 micron thickness of copper metal 32 is plated onto the seed layer as shown in FIG. 9. FIG. 9a shows a view from above of the rectangular well, whereas FIG. 9b shows an end view of the electroless plated metal walls and printed transparent conductor 30. The copper thickness 32 modifies the actual bus bar and tram line spacing by virtue of the fact that the electroless plating is deposited on all exposed surfaces of the seed layer, hence a 10 micron wide seeding layer track will increase to 12 micron and the adjoining transparent window width, located between the opaque metal tram lines, will be reduced to 98 microns for a 1 micron electroless plated copper thickness. The resulting electroless plated copper film possesses a transparent window bus bar resistance of about 800 Ohms for a window length of 20 cm.

The transparent conductor window, in high transmissivity form, possesses a resistance of the order of 200,000 Ohms with the combined structure exhibiting a resistance of about 415 Ohms.

A transparent conductor of low resistivity (for example, a resistivity equivalent to a magnetron sputtered thin film having a resistivity of 2×10⁻⁴ Ω-cm) and having an equivalent area to the tram line structure described above would have a resistance of about 33,000 Ohms, which is at least 79 times more resistive than materials used in the tram line structure above, and it would absorb much more visible waveband radiation.

Within the tram line rectangle (or “constraining channel”), an insulating or a conducting channel or a combination of both may be provided, within which is defined the transparent conducting element in discrete or continuous form. The transparent conductor element can be a single layer structure or it can be a multiple layer structure comprising one or more discrete or blended materials. The transparent conducting element defined within the constraining channel can be due to the deposition of one droplet of ink or multiple droplets of ink. The multiple droplets of ink can be of the same chemical composition or of different compositions and chemistries such that the resulting liquid layers can be immiscible or can become fully mixed before the structure solidifies. The first droplet or multiple droplets of the same chemical composition can be partially dried to form a gel or semi-solid state that can then be impregnated with a second droplet or multiple droplets of ink, thus acquiring the further chemical properties. FIG. 10, for instance, shows a conductive well 52 with an optically matched polymer infill 54 under the transparent material layer 30, between the metal tracks 50, to planarise the structure.

Current OEM print heads can be used to dispense precise quantities of ink into the channel which defines the conductor without the need for high resolution placement or very small volumes of ink in each drop.

An example of a patterned transparent conductor follows.

Assuming a square of aluminosilicate glass has a surface area of 10 cm by 10 cm and a thickness of 700 microns, it is highly transparent over the visible waveband covering 400 nm to 800 nm and also highly resistive. Onto this surface is printed, using conventional or digital, plate or plateless, off-set lithography, a series of parallel lines that have the following properties:
a printed line height of 3 microns;
a printed line width of 15 microns;
a printedline spacing of 985 microns; and
a printed line pitch of 1,000 microns.

The printed line material bonds to glass (which may act as a substrate) and acts as a receptor surface for electroless copper plating 32.

The printed lines are coated selectively, that is, only the lines are coated, and not the surrounding area, with a copper film of thickness 100 nm that exhibits a moderate resistivity of 10⁻⁵ Ω-cm. The geometry of the structure implies a conductor width of 21.1 microns due to the plating process as described above, and a cross-sectional area of 2.11×10⁻⁸ cm². The resulting resistance of a single 10 cm long conductor is 2,370 Ohms, which equates to a sheet resistance of 1 Ohm per square.

Two conductors are spaced 1 mm apart and are connected at their ends to form a rectangular containment well. The electrical connection nodes are such that the two separated conductors behave as a single conductor of double width and the same thickness. The connector (or link) resistance is effective over a connection length of 985 microns and a resistivity of 10⁻⁵ Ω-cm, providing a resistance of 46.7 Ohms and a sheet resistance of 1 Ohm per square. The link resistance is small in comparison with the long conductors. The combined resistances of the connectors and the conductors give a total resistance of the rectangular well of 2390 Ohms or 23.9 Ohms per square (because of the change in aspect ratio between the connector and conductor). However, this assumes that the two conductors are separate whereas in fact they are connected. Consequently, the combined conductors will provide a sheet resistance of 1 Ohm per square because the resistance has halved but the area has doubled. It must be noted that the ratio of the resistivity to film thickness has remained constant even though the area of interest has changed.

Filling the rectangular containment well with a transparent conducting material that is electrically connected to the conductive walls of the well gives a sheet resistance which is the same as that calculated previously because the connectors bridging the two long conductors effectively short-circuit the material that is deposited between them. The aim of this structure is to ensure that charge generated in the centre of the well can reach the conductor and be carried away, the structure thereby acting as a continuous transparent conducting rectangular window.

It is known that thin film metal bus bars can be deposited onto a thin film transparent conductor to provide a means of removing charge as required above, for example, in a solar panel. The use of a bus bar is no different in design concept from the example above; it is only different in the manner in which it is produced and in its visibility to a user.

It is possible to isolate a rectangular well by removing the linking connections, thereby creating two conductors 20 spaced 985 microns apart, where the spacing is filled with a transparent conducting thin film 30. This is illustrated in, for example, FIG. 11. In this case, if the two conductors 20 are connected to a multimeter or other form of resistance measurement, they will read a total resistance of 1 MΩ or so. If the length to width aspect ratio is 101:1, the resulting sheet resistance of this isolated well will be 9,900 Ohms per square.

It is also possible to create an interdigitated electrode structure as shown in FIG. 12, which resembles two hair combs 70 with intermeshed teeth 72, which provides a structure that contains a large number of interconnected wells. The counter electrodes can be connected to the same potential as the corresponding electrodes or they can be connected to an alternative potential. This provides a means of removing charge from the transparent conducting window material, as required, for example, in solar energy generating sources, such as in solar cell applications.

The transmissive area is dictated by the ratio of the metal conductor to the space between conductors. In this example, the ratio of the space-to-metal introduces a transmission loss of order 1.5%. This assumes that the instrument used to determine the total transmissivity can determine the influence of the metal conductors.

It is possible to measure the metal electrode that connects regions of the transparent conducting material. This electrode can have a very low sheet resistance, typically less than 1 Ohm per square. It is also possible to use a 4-point probe to measure the sheet resistance of the transparent conducting material deposited between the interdigitated electrodes. In this case, the sheet resistance is high, typically over 1,000 Ohms per square. The issue discussed below is whether these two statements are compatible with respect to the overall behaviour of a hybridised transparent conducting window.

Assuming that the interdigitated electrodes 70 of FIG. 12 are at ground potential, in order for an induced charge to be able to sink to earth, it is necessary that the rate of dissipation of charge exceeds the rate of accumulation. This requires the understanding the dielectric relaxation time, τ_{dr}, which is a measure of the time it takes for a charge (electrons or ions) placed on a previously neutral material to relax to a uniform charge density in an isolated material or to leak to zero, if the material is connected to an electrical earth. The dielectric relaxation time, which is the product of the permittivity of free space, ∈ₒ, the relative permittivity of the material, ∈ᵣ, and the resistivity of the material, ρ, is given by:
τ_{dr}=∈ᵣ·∈ₒ·ρ [1]

Assuming that the transparent conductor, which is located between the two metal conductors, which are themselves at earth potential, has a resistivity of 100 Ω-cm and a dielectric constant of 5, the resulting dielectric relaxation time, τ_{dr}, will be 4.42×10⁻¹¹ seconds (44.2 pico seconds). This suggests that the charge should leak to earth very quickly; effectively instantaneously.

In order to determine whether the charge deposited on the material can move quickly enough for the desired application-of the conductor, it is necessary to consider the mobility of the free charge, μ_{con}, where μ_{con} is the inverse of the product of free charge carrier density, n, electronic charge, q, and the material resistivity, ρ, and is defined as:
μ_{con}=1/nqρ [2]
or, in terms of the dielectric relaxation time:
μ_{con}=∈ₒ∈ᵣ/nqτ_{dr} [3]
From equation 3, for the dielectric relaxation time, τ_{dr}, to be low (that is, for relaxation to be quick), conduction mobility, μ_{con}, must be high. The density of free carriers can be increased to help this, but increasing the density of free carriers also influences the optical transmissivity negatively, and so it is more advantageous to increase the conduction mobility rather than the free charge carrier density.

The conduction mobility does provide a measure of the transit velocity from the charge dissipation source to the earth potential bus bar, because the material might not be of a form that possesses isotropic properties. This points to the fact that the manner in which nanoparticles contained in an ink droplet, ejected from a drop-on-demand ink jet print head come together on the receiving surface, is of significant importance in producing a high mobility device, as is the nature of any post-treatment (e.g., laser or rapid thermal annealing).

The transparent conducting material can take many forms, for example:
Inorganic transparent conducting oxides [ATO, TO, ITO, FTO, ZnO, SrCu₂O₂, etc.]
Organic [Pedot-PSS, Polyaniline, etc.]
Organically modified ceramics [Metal alkoxides, etc.]

It has been shown by the example above that a transparent electrode may be produced that possesses very high optical transmissivity and electrical conductivity by combining printing processes. This combination produces a thin, highly conductive line that forms one wall of a constraining trench, the line not being visible at the standard viewing distance associated with laptops, mobile phones, hand-held personal processors and electronic games. The combination also gives a transparent conducting material constrained within the trench, that not only provides the electrical charge mobility, but also very high optical transmissivity across the luminous waveband.

Another method of making patterned or whole area (discussed below) transparent conductors involves surface etching and drop-on-demand ink jet printing as a further hybrid processing method.

It is known that screen printed metal tracks can be printed onto a transparent conductor to provide a means of providing an electric current to the transparent conductor, making use of a low resistance electrical bus bar/conductor that is not transparent. For display devices, it is necessary that such a bus bar is not directly observed by a user, since this would detract from easy viewing of the information displayed on such a device, which means limiting the bus bar width to about 30-50 microns, depending on the viewing distance and the actual resolving power of the user's eye. It is known that screen printing cannot produce a feature width of smaller than about 50 microns without considerable effort and particularly over large surface areas.

It is known that digital offset transfer plate/plateless lithographic, Gravure offset, and soft contact lithographic printing can produce very small features, in some cases much less than 10 microns. This provides a means of generating a transparent conducting device that is based on a low resistance conductor, that is opaque and that is in contact with a continuous stripe or an array of transparent conductor windows which themselves possess low conductivity but which exhibit very high transmissivity in the visible waveband. The two adjoining materials can be independently modified so as to provide an optimised low resistance bus bar and high transparency conductive window performance independent of each other. This means that a transparent conducting element can be tailored to suit a given device type.

Methods that can be used to produce the constraining channel include:
Continuous ink jet printing
Drop-on-demand ink jet printing
Ion beam etching
Laser ablation
Laser direct write deposition
Lithographic printing
Offset lithographic printing
Offset stamping
Patterned substrate (foils, sheets, paper) laminates
Plasma reactive ion etching
Screen printing
Soft contact lithography
Stencilling
Surface dewetting
Wet etching

FIG. 13 shows a stripe structure comprising a metallic conductor (MC) 20 and a transparent conductor (TC) 30 deposited on a substrate medium 10 and electrically connected such that the metallic conductor 20 serves as a low resistance electrical highway providing electronic charge to be fed into the adjoining transparent conducting element 30 via the overlapping connection zone 40.

As shown in FIG. 6, the metallic conductor 20 can be formed as a nanoparticle 22 or microparticle (24 of FIG. 2a) structure that can be opaque or translucent and can be in the form of a connected particulate or a laser annealed form that includes amorphous, microcrystalline, polycrystalline, and single crystal dependent upon the film-substrate-processing scheme employed.

It is possible to use a modification of the patterned transparent conductor described above to provide a low cost means of producing a material that exhibits very high optical transmissivity with low electrical sheet resistance. The following examples can again use a 10 cm by 10 cm plate of glass, or a sheet of plastic such as PET or any other optically transmissive material. Examples of the basic process which will be further described below are:
1. Embedded+Coated
2. Integrated planar

All versions of the process make use of the same essential feature, which is the inclusion of an array of conductive bus bars that are not detectable by eye that sweep charge into or out of the whole area transparent conducting material that covers, and electrically connects to, the bus bar array.

For whole area structures, the bus bars can be defined as orthogonal sets of electrodes so that any size of panel can be cut from a larger sheet without impairing the overall electrical performance whilst still supplying an array of bus bar contacts along the edges of the diced plate.

1. Embedded+Coated

As shown in FIG. 14, a glass plate 80 can be coated with a self-assembled monolayer (SAM) 82 that provides a highly non-wetting surface. A laser is scanned over the plate surface to define a series of grooves 84 in the near surface and plate surface, the grooves being below the detection limit of the eye and forming a set of containment trenches. The grooves, which can be produced using other methods, can be all in one direction (x or y) or in orthogonal directions (x and y), where the cross-over points provide connectivity between the both axes. The resulting grooves are filled with fluid 86 which can be achieved using precision spraying or drop-on-demand ink jet printing, where the wetting nature of the groove wall causes the ink to flow into the etched trench, leaving the surface free of ink because of the differential nature of the surface energy in the groove and that of the non-wetting SAM coating on the exposed surface between the grooves. The resulting solidified metal in-fill does not completely fill the groove so that the transparent conducting coating 88 can also flow into the groove and provide a direct electrical connection to the metallic bus bar. The SAM layer is easily removed using atmospheric ozone or UV lamp exposure, which chemically etches the monolayer in a manner similar to the photoresist residue removal approach associated with conventional semiconductor processing. The whole area transparent conducting coating can be applied using numerous methods, including:
Doctor blading
Drop-on-demand ink jet printing
Electrostatic printing
Electrostatic spraying
Gel pressure lamination
Pressure spraying
Screen printing

The whole structure is then thermally annealed to effect good electrical connectivity and electrical performance between the two materials without impairing the very high optical quality. In this instance, the conductivity of the transparent coating is designed to provide good charge mobility but only over a limited distance; that is, to the nearest bus bar.

This embedded and coated whole area transparent conductor can be used in conjunction with a wide variety of substrate media, including crystalline silicon, dye-sensitised inorganic oxides, and organic/polymeric semiconducting for solar cell construction

2. Integrated Planar

An alternative approach to the preparation of the whole area transparent conductor is to use the hybrid printing method described above under the Patterned Transparent Conductors head, but using the ink jet printing process to deposit an optically transparent but electrically insulating material into the well, partially filling the deep well structure to the current limit of the digital off-set lithographic printing process employed to print the containment trench walls at a feature size below that detectable by eye. The in-fill material can be used to provide optical matching to the substrate media in order to minimise reflection losses. Once this filling has been completely dried, the whole area coating of the transparent conducting material can be completed in a manner similar to that described above. The completed substrate includes integrated metal bus bars and an encapsulating transparent conducting coating set on optical clear insulator, the insulator partly filling the containment trenches, and is thermally processed to provide the necessary performance and to promote thermal stability.

The printed containment well depth in the above examples is limited by the thickness of the printed seed layer, which is of the order of 2 microns for the off-set lithographic printing process. However, this layer thickness may be reduced with alternative processes, such as soft contact stamping, which could provide a seed layer thickness significantly less than I micron. Soft contact stamping has been shown to produce sub-micron scale features of nanometre thickness from a variety of polymeric materials over an area of about 30 cm by 30 cm, so much larger areas need to be patterned in a step-and-repeat process.

A further approach to manufacturing the whole area transparent conductor is to coat the whole surface area of the substrate media with the seed material and to use a laser ablation process to selectively remove the seed material thereby producing the required shallow groove in a material, which can then be electrolytically plated to provide the high conductivity copper bus bar structure whilst still retaining a very high open area that is devoid of any seed material or plated copper.

For some applications of the transparent conductor, it is not possible to use the processes described above. There are alternatives, however, which are described below and include:
1. in-line striped transparent conductor,
2. multilayer transparent conductor, and
3. mixed ink transparent conductor.
   1. In-line Striped Transparent Conductor

It is possible to print a transparent conductor using a basic nanoparticle transparent conducting oxide based ink. The drop-on-demand ink jet printing feature resolution of 50 microns can be used for this process, the ink typically containing a solid content of ATO or ITO nanoparticles in the range 0.1% to 15% by volume. For the specific case of a 3% by volume solid containing ink, the resulting solidified transparent conductor ink, for a 200 micron wide transparent line electrode, has a thickness of order 200 nm. Given an electrical resistivity for the transparent conducting oxide film, after thermal annealing, of 10⁻³ Ohm-cm, the resulting sheet resistance will be of the order of 50 Ohms per square, with an associated transparency exceeding 90% at 550 nm. The individual pixels covered by the addressing line transparent conductor have a width of, for example, 200 microns on a pitch of 250 microns. The resulting line resistance for a 10 cm long transparent is 20,000 Ohms. Given the geometry of an individual pixel cell it is possible to replace the transparent conducting oxide between the pixels with a conducting link, for example one based on silver nanoparticles. In this case, the series resistance is reduced by 19% due to the higher conductivity nature of the links. As a result, the total resistance of the 10 cm long transparent electrode reduces to 16,200 Ohms.

2. Multilayer Transparent Conductor

If the luminous transmissivity can reduced, it is possible to construct a trilayer (though it could be binary or higher) transparent electrode using, for example, drop-on-demand ink jet printing. The multiplayer transparent electrode will comprise the following layer sequences as shown in:
TCO/Metal/TCO
TCO/Metal/TCO/Metal/TCO

The same 10 cm long and 200 nm thick transparent conductors can be used as were cited in the in-line transparent conductor described above. The metal nanoparticles can be, for example, silver, and the particle size and packing produce an equivalent thickness to the transparent conducting oxide films, which is 200 nm. The resulting resistance of a three-layer transparent conducting oxide-only structure is of the order of 6,600 Ohms. The equivalent resistance of the trilayer vertically stacked structure is of order 900 Ohms. The resulting transparent electrode resistance values calculated do not take into account any synergistic effects that might occur during annealing/sintering and that might promote a highly conducting band thickness greater than that actually due to the printed metal thickness. The transparent conducting oxide and metal nanoparticle film thickness can be adjusted so as to achieve a desired transmissivity-conductivity factor and that the number of layers comprising a transparent electrode can be selected to achieve an overall electrode resistance and luminous transmissivity.

The transparent conducting oxide portion of the multilayer can be continuous, whereas the metal layer portion of the multilayer can be deposited in a selective fashion so as to promote the equivalent of higher conductivity links within a continuous sea of transparent conducting oxide, while permitting the actual pixel areas to remain higher in luminous transmissivity.

3. Mixed Ink Transparent Conductor

This process makes use of a printing process that deposits a liquid film containing a mixture of nanoparticle inorganic transparent conducting oxide (i.e., TO, ITO, ATO, ZnO, etc.) and nanoparticle metal (i.e., Ag, Au, Cu, Al, etc.). The mixed ink enables the printing of whole area and patterned transparent conductors that exhibit a sheet resistance of less than 800 Ohms per square with a transparency of at least 85% at 550 nm wavelength (which is central to the luminous waveband). In order to achieve this in a single ink, a highly conductive particle can be combined with a transparent conducting particle to introduce a small number of conduction centres in a p-type semiconducting sea.

A pure Ag nanoparticle film would possess a low luminous transmissivity due to the light absorbing nature of the silver. However, a random low concentration of metal nanoparticles dispersed within the, for example, transparent conducting oxide (TCO) coating will provide a means of enhancing charge injection shared between several nearest neighbour particles.

The ratio of the metal particle size to the transparent conductor particle size is an important factor in optimising the electrical and optical performance of the mixed particle film. As shown in FIG. 17, assuming the particles are spheres, this is because equal sized particles will take up a larger volume for the same number of interparticle connections. Smaller. particles that would achieve the same contact density, albeit at a slightly reduced contact area due to radius of curvature of the particles and taking into consideration the relative effects of surface roughness. It can be seen that ordered spheres can be closely-packed in either face-centred cubic or hexagonal structures, depending on the manner in which subsequent spheres are placed on top of the previously deposited sphere. For a two-sphere system of equivalent size, the packing argument remains the same, ignoring chemical considerations at this time. However, if the two spherical particles are of different size, then a structure such as that observed with the solid ball model of the NaCl lattice, namely a face-centred cubic structure, can be envisaged, which provides a minimum volume for a maximum nearest neighbour contact density (6 nearest neighbours) for each particle type. It is possible to construct this packing structure in a manner that permits metal-to-transparent conductor particle contact with or without transparent conductor-to-transparent conductor contact.

In order to achieve the maximum charge transfer, it is necessary to select a metal particle that is small enough to reside interstitially between the close-packed transparent conductor particles whilst still contacting each and permitting the transparent conductors to touch each other. Clearly, perfect packing of the particles is an idealised notion, but from a practical standpoint, it does provide a means of combining metal and transparent conductor particles in such a manner that maximum conductivity and transmissivity can be achieved in a single coating that would not be achieved from a coating containing only one particle type.

Assuming that each particle is spherical and of the same diameter, it would be expected that one metal particle would contact 4 TCO particles. This suggests that, in a preferred embodiment, for a 3% solution of ATO, 0.6% of the ATO can be substituted by Ag nanoparticles, thereby producing a 2.4% ATO/0.6% Ag/Aqueous/Surfactant ink. Assuming all of the Ag nanoparticles promote an increase in luminous absorption, it is anticipated that the transmissivity of about 94% would reduce to a value of the order of 70%. However, given the multiple particle stacking nature of the thin film, some of the Ag particles will be aligned directly above other Ag particles, thereby reducing the effective absorption due to a reduce absorption capture cross-section, suggesting that the effective luminous transmissivity could be as high as 88%. In other embodiments, the proportion of Ag nanoparticles is between 0.1% and 10%, and in some cases the solution comprises a solvent such as a glycol ether rather than water.

If the metal particle were of a size that permitted contact between transparent conductor nearest neighbours and the associated metal particle, the volume of metal would be reduced over that area for identical particle size and the effect of direct absorption of light would be reduced in the ratio of the volumes. Clearly there is a specific relationship between the size of the metal particle and the transparent conductor on purely geometrical grounds if all surfaces are to touch, which from geometrical and mathematical considerations suggests that the metal particle diameter (assuming a spherical particle) must be of the order of 0.42 times the diameter of the transparent conductor. This suggests that a transparent conducting particle with a 18 nm diameter should be combined with a metal particle with a 7.56 nm diameter, as is the case in a preferred embodiment. In certain other embodiments, the metal particle has a different diameter, said diameter being less than 10 nm.

Binary nanoparticles systems behave differently from tertiary nanoparticle systems because of the relative potential interlocking behaviour of the particles, hence, the need for specific surfactants to assist particle flow and thereby reduced colloid/slurry viscosity. In the preferred embodiment such surfactants act to reduce the surface tension, typically to 30 dynes/crn or less.

Notwithstanding the fact that many nanoparticles are not spherical, a similar argument to that presented above still exists and as such, a metal particle dimension-to transparent conducting particle dimension ratio in the range of 0.415 to 0.435:1 (TCO particle) is envisaged.

In this example, the ink contains a distribution of both metal and transparent conducting oxide particles that, if not filtered, affects the manner in which such particle packing is achieved. Notwithstanding this, the metal particle-transparent conductor particle mix provides a benefit over a purely transparent conductor particle coating based on equivalent transparent conductor material.

The variable size of the metal and transparent conducting nanoparticles as described above assumes that the charge mobility within the transparent conducting particle is high and the intrinsic defects do not significantly limit the transport of charge carriers because the smaller metal particles will not actually be touching each other, and as such, do not create a direct conduction path for charge transport within the transparent conductor.

If the charge transport is limited by the defective nature of the transparent conducting nanoparticles, an alternate approach is to ensure that the metal particles touch each other at the same time as they touch their nearest neighbour transparent conductor particles. In this instance the dimensions of the metal and transparent conducting particles has to be the same in order to produce a close packing hexagonal structure that permits the necessary particle interconnection. In this case, the volume of metal will be increased over the two size particle ink described above with a concomitant impact on the optical transmissivity.

Given the difference in the conductivity nature of the semiconducting and metallic nanoparticles, it is essential that the stability of the Ag-ATO nanoparticle co-ingredients, to be stabilised in the same solution, be addressed so as to achieve optimum particle packing and in the ideal case, in a self-aligned manner.

It is also possible to use two independent printheads placed back-to-back or combined in a suitable locating jig such that droplets ejected from each printhead are co-incident at the constrained well centre to be filled or the surface area to be coated (within the limits of the accuracy of droplet ejection cone angle and printhead-to-substrate surface spacing). Given that for some printheads, it is possible to use a grey scale (for example, a scale with 8 levels, though other levels of processing are possible) approach to modify, in a digital manner, the total volume of ink that constitutes the equivalent of a single large volume drop, it is anticipated that subtle changes in nanoparticle mixing can be achieved at a local level. This means that the properties of adjacent segments of the same electrical conductor can be modified so as to achieve local changes in electrical conductivity, optical transmissivity and thickness.

Clearly, the concept described above can be applied to the generation of a tertiary, quaternary or higher order mixed nanoparticle transparent conducting element including the creation of inorganic-organic mixes and nanoparticle-polymer mixes by adjusting the number of printheads used and redesigning the multiple printhead jig if co-incident printing or precision back-to-back printing is required. Using the method of mixing nanoparticles to influence the electronic behaviour of the resultant thin film structure before and after annealing, it is possible to anticipate the deposition of a patterned transparent conductor that is based on p-type or n-type material, which can be used to produce transparent anodes and cathodes for applications including all-transparent (see through) displays and top transparent contacts for a wide variety of flat panel displays including silicon integrated micro devices.

The mixed transparent conductor can be tailored to provide suitable contact properties that affect the contact resistance, electronic barrier height, and charge transfer efficiency between the transparent conductor and the material with which it is in contact. It is anticipated that this can be achieved either by modifying the specific ratios of the nanopowders that comprise the thin film contact or by dispersing one or more nanopowders in a suitably conductive material such as a doped or intrinsically conducting polymer (e.g., polyaniline, Pedot-PSS) or a chemically derived conductive glass (e.g., sol-gel tin oxide). It is expected that the inclusion of such nanoparticles in, for example, the conducting polymer film will assists the control of the electronic charge transfer between the transparent contact and the media to be contacted, especially conjugated or oligomeric semiconductors due to electronegativity modification and charge injection barrier reduction brought about by the concentration and nature of the nanoparticle, and will, to some degree, minimise the field-assisted transport of oxygen ions from the inorganic transparent conducting oxide particles into the material being contacted. The minimisation of oxygen ion migration to the contact-material interface will also suppress interfacial charge trapping effects that are known to cause dipole losses when reacting with hydrogen to form OH⁻ ions. In this context, it is possible to provide a multilayer structure using both material types based on separate ink supplies and/or drop-on-demand ink jet printheads in order to produce abrupt and diffuse interfaced structures that provide a transparent contact on oxygen-sensitive materials.

The production of both n- and p-type conducting transparent electrodes opens up the possibility of creating p-n junctions based on the printing of p-type and n-type materials that can be achieved either as conventional vertical stacked structures or as a single layers comprising a homogeneous distribution of n- and p-type material in close proximity to create novel electronic structures.

In order to produce a transparent conducting electrode possessing the lowest resistance, it is necessary to optimise the charge mobility within a nanoparticle and the charge transfer across the inter-particle contact surface area. In this respect, this contact interface exhibits a low contact resistance and charge transfer by virtue of matching the electronic band offsets of the two materials. The choice of material, for example, for a mixed metal-oxide nanoparticle ink, must exhibit a low electronic charge barrier which can be determined using band-offset calculations. For particle-based coatings, it can be important that the contacting surface area is made as large as possible to minimise interfacial contact resistance, which in the case of a coating comprising transparent conducting particles dispersed in a conducting binder, can be achieved by ensuring that the choice of conducting binder readily wets the nanoparticles and when in contact provides the best electronic conduction band alignment.

Suitably coated transparent conducting particles can be produced using the selective withdrawal technique. This provides means for coating individual particles with an electronically matched material and the matched material can readily undergo reflow and coalescence with nearest neighbour particles when heated so as to produce a larger contact area that is controlled by surface tension and surface wetting. The resulting inter-particle plug will then provide means for mini missing charge transfer throughout the transparent conductor.

The mixed nanoparticle ink can include optical micro and sub-micro spheres that are optically clear such as would be the case with silica or polyethylene structures. The micro spheres, which can be conducting, semiconducting, or insulating, enhance luminous transmissivity and also influence the geometrical dispersion of the emitted light, as well as promoting improved durability and wear resistance. The nano- or microspheres can be added to a printed transparent conductor before it has been dried so that the spheres are retained in the material as shown in FIG. 15. The nano- or microspheres can be added to a surface to provide a distribution of dried spheres 94 that is then embedded by printing a second transparent conductor ink 96, such as a metal alkoxide sol or intrinsically conducting polymer, that coats around the spheres to provide mechanical binding and electrical transport. FIG. 15 shows a transparent or opaque substrate 90 with a first ink containing a transparent bonding layer 92; a second ink containing insulating or conducting microspheres 94 which bond to the first layer as it dries; and a third ink containing a transparent conductor layer 96.

FIG. 16 shows transparent conducting oxide nanoscale particles 97 and transparent insulating sub-micron spheres 99 embedded in a transparent conducting layer (in this case an ICP polymer) 98, on a substrate 100.

The mixed nanoparticle ink can include dyes and pigments that provide transmissive, reflective, and luminescent colouration.

A number of applications, such as electrochemical or electro-optical sensors can require a transparent electrode that permits a gas or a liquid to pass through it and penetrate into the underlying material where it undergoes a chemical reaction that is assisted by the electric field provided by the transparent electrode in conjunction with a counter-electrode. Porous electrodes may be made by several methods, including:
Controlled surface wetting through a laser etched non-wetting SAM monolayer or deposited coating
Controlled surface wetting through ink additives
Controlled surface wetting through photolithographic patterning of a non-wetting SAM monolayer
Controlled surface wetting through selective area electrostatically-induced electrical potential
Controlled surface wetting through self-assembled monolayer patterning
Molecular scale pattern templating
Nanoparticle aerogelation
Nanoparticle self-organisation

In the case of the molecular scale pattern template, an ink containing a very low concentration, in the range 0.001% to 5%, of a self-assembling polymer is first deposited and dried to provide a suitable interconnection pattern. A second ink containing the specified transparent conducting materials that is chemically compatible with the template monolayer is then applied using, for example, drop-on-demand ink-jet printing. The transparent conductor ink decorates the monolayer template pattern in those areas that expose the underlying substrate surface. The complete structure is then exposed to a chemical environment, such as Faraday cage oxygen plasma, which provides a means of removing the monolayer template pattern without damaging the surface that is exposed when the template material is removed. The resulting porous transparent conductor can be left in the as-deposited state or can undergo rapid thermal or pulsed laser processing to enhance the transparent conductor performance, providing allowance is made for the potential damage that might accrue to the underlying material in contact with the porous transparent electrode.

Additives, such as specialist surfactants and surface structure alignable liquid crystals, can be included in the transparent conductor ink design. These additives can promote nanoparticle or in-situ chemical reaction self-organisation. The characteristics of such self-organisation dictate the extent to which the porosity is maintained at the nano- or micro-scale. The use of surfactants in particular embodiments provides a surface tension of around 30 dynes/cm.

The composition of the transparent conductor ink can be so modified so as to promote spontaneous localised dewetting due to the nature of the ink viscosity and surface tension, and the substrate surface energy, which can induce differential wetting behaviour via the Marangoni effect promoting or resisting natural wetting behaviour. In this respect, mixed solvent inks are known to affect the wetting of surfaces and, in some cases, to promote controlled patterning of surfaces from an array of discrete dots to interconnected spinoidal dewetting and dendritic patterning.

A self-assembled non-wetting monolayer can be used, deposited, for example, using drop-on-demand ink jet printing, the monolayer being patterned in a step-and-repeat manner using an integrated UV Lamp patterning or Laser digital pattern transfer to create wetting and non-wetting regions on the surface. A second transparent conductor ink is delivered to the surface using ink jet printing that segregates the wetting lands to produce the required transparent conductor layout, with the patterning-defining monolayer material being removed using chemical means.

Applications for transparent conducting structures other than transparent electrodes for flat panel display devices are possible.

Numerous applications have been conceived that benefit from the application of patterned transparent conducting thin films, including:
2- and 3-dimensional periodic structures
Electrochromic “Smart” windows: [patterned and whole area]
Electronic blinds and large area shutters
Electro-optic micro shutters: [LCD, ferroelectric, electrochromic]
Electro-optic switches: [organic and inorganic]
Flat panel displays: [Low and high resolution, current and field switched active and passive addressing]
Integrated optical devices: [modulators, detectors, spectrum analysers, converters, spatial light modulators]
Light emitting diodes and lasers: [organic, polymeric, inorganic]
Micro sensors: [discrete devices and arrays for gas sensing]
Non-linear optical devices: [organic and inorganic active waveguides]
Photovoltaic cells and switches: [organic and inorganic]
Touch-sensitive switches: [capacitive]
Transparent antennas
Transparent heaters and ice demisters: [large area and integrated device micro heaters]
Transparent micro heaters

There follow examples of the above in order to illustrate the diverse manufacturing potential of printed and directly patterned transparent conductors.

2- and 3-Dimensional Periodic Structures

It is known that colloids have the ability to self-assemble into 2- and 3-dimensional periodic structures under specific conditions. Given control over the nanoparticulate size, dielectric constant, monodispersivity, refractive index, and the wavelength of the incident photons, it is possible to construct photonic band gap structures, including tunable band gap behaviour, that exhibit unique electromagnetic radiation diffraction gratings, routers, interconnectors, and switches. In this respect, mixed nanoparticles and hybridised nanoparticles in organic systems, including controllable orientation polymers and organic crystals, provide a means of expanding potential applications and performance. diversity, particularly for applications covering all-optical integrated micro photonic circuits, all-optical computers, and all-optical telecommunications systems.

Touch-Sensitive Switches [Capacitive]

A manufacturing method based on one or more of the ideas and concepts described in this document can be used to produce the transparent contact for a capacitive touch switch.

Photovoltaic Cells and Switches

A manufacturing method based on one or more of the ideas and concepts described in this document can be used to produce a transparent contact for a light dependent proximity switch for use on, for example, a control panel.

Transparent Antennas

A manufacturing method based on one or more of the ideas and concepts described in this document can be used to produce a transparent antenna pattern and interconnection that can be used in, for example, automobile screens and on contactless radio-frequency smart cards, electronic money vouchers, security devices that include displayed media, and electronic passes.

Transparent Heaters and Ice Demisters

A manufacturing method based on one or more of the ideas and concepts described in this document can be used to produce heated transparent screens and mirrors. A resistive transparent heater, as might be employed in the heating of aircraft windscreens, automobile windscreens, internal/external mirrors and lights coverings, formed in a spiral, straight line, or any other pattern can possess a wide range of resistance based on the electrical resistivity, length, width, and thickness selected for the transparent heating element. The terminations to the transparent heating element could be deliberately made metal-rich or graded up to pure metal by, for example, using a dual printing process to print the transparent conductor with one ink based on transparent conducting oxide nanoparticles and the metal connector pads with a second ink based on metal nanoparticles of chemically convertible solution.

Transparent Micro Heater

A transparent micro heater would be required to permit the heating of a chemical reagent in a lab-on-a-chip experiment where the reaction driven by the heating process needs to be continuously monitored using optical methods. The optical method can be achieved using end-butted optical waveguide transfer of transmitted light that is provided by a diametrically opposed complementary waveguide or light-emitting device that provides the means of illuminating the chemical reaction cell. The heating device could be a simple planar structure that heats the reaction cell from above or below; or it can be a planar structure that heats the reaction cell radially since the heater configuration would form a containment well.

The resistance of an annular micro heater including the resistive legs that contact the annulus is given by:
R_{Heater}=πrρ/2wd [4]
or
R_{Heater}=(2πr−x)ρ/wd [5]
Where,
ρ=electrical resistivity of the transparent conducting film [Ω-cm]
d=thickness of the transparent conducting film [cm]
w=width of the annulus [cm]
r=radius to the centre of the annulus [cm]
x=spacing between contact electrodes from the same side [cm]

The resistance of the annulus is determined by the transport path being around both halves of the annulus for electrodes that contact the circular heater from opposite sides (180° apart). For example, a 100 micron diameter well is formed with a transparent conducting film annulus of width 50 microns and connecting legs of length 50 microns. The transparent conducting film has a thickness of 200 nm (0.2 microns) and exhibits a moderate electrical resistivity of 10⁻¹ 106 -cm. The resulting micro heater resistance is 19,634 Ohms with a luminous transmissivity of more than 90%.

Further embodiments, relating to an electronic device and method of manufacture thereof are now described.

Electronic device and method of manufacture thereof.

A preferred method of manufacture is used to make a wide range of electronic devices, including transistors, resistors, conductors, diodes, capacitors, inductors, surface coils, josephson junctions, opto-electronic devices such as photovoltaic cells and photodiodes, quantum wire devices and interconnections, and composite devices made from a plurality of such devices, and to make a wide range of circuits formed from such devices.

Part of one such device, an organic field effect transistor (OFET), is shown in FIG. 18, viewed from above. The transistor includes a drain contact 201 and a source contact 203 separated by a gate 205. The drain contact and the source contact each includes droplet impact lands, or receiving portions, 207, 209.

In making the device the deposition material, in this case a conductor, is deposited on the droplet impact lands 207, 209 and flows to cover desired areas thus forming the drain contact 201 and the source contact 203. In this case, the deposition material is an antimony tin oxide nanoparticulate dispersion although other materials can be used, such as any solvent based or other spreadable ink.

In the present example the deposition material is deposited using an ink jet printing technique. In other examples, instead of such ink jet printing technique, any technique which can deposit a pre-determined amount of material onto a pre-determined location is used, such as drop on demand printing techniques, and more particularly high resolution spraying or liquid continuous jet streaming.

The portions of the surface on which the drain contact 201 and the source contact 203 are located are, in the preferred embodiment, treated prior to deposition to alter the wetting properties of those portions of the surface. In the present example, that treatment is by laser direct ablation of the surface.

In alternative embodiments, the treatment is by corona discharge or by application of other electro-magnetic radiation.

The change in wetting properties of portions of the surface has the effect that, when the deposition material lands on the droplet impact lands its flow is restricted, in whole or part, to desired areas, in this case the drain contact 201 and source contact 203 areas, by the difference in wetting properties between those desired areas and adjacent areas of the surface.

The droplet impact lands, or receiving portions, in these embodiments act as reservoirs from which the deposition material flows to desired portions of the surface, contained by the variation in wetting properties across the surface. In such embodiments, the droplet impact lands, or receiving portions, are for example of a size of the order of the resolution of the device applying the deposition material, or larger. In contrast, parts of the desired portions of the surface to which the deposition material flows from the droplet impact lands, or receiving portions, are smaller than the resolution of the device applying the resolution material. Thus such embodiments enable the formation of electronic devices with features of a smaller scale than possible with conventional printing techniques.

Furthermore, in particular ones of such embodiments, the droplet impact lands, or receiving portions, are remote from parts of the desired portions of the surface, to which deposition material flows. Thus, those desired portions are not affected by spatter of the deposition material, or washover of impact waves of the deposition material, caused by impact of the deposition material on the droplet impact lands, or receiving portions.

Those features of preferred embodiments are illustrated in a simple way in FIG. 18 where it can be seen that the droplet impact lands 207, 209 are of larger scale than the central portion of both the drain contact 201 and the source contact 203. The droplet impact lands 207, 209 are also relatively remote from those central portions, so that the central portions, at least, are not affected by spatter of the deposition material, or washover of impact waves of the deposition material.

FIG. 19 shows one part of surface on which the drain contact 201 of the embodiment of FIG. 18 is formed. A droplet of deposition material 210 is also shown immediately after it has landed on one of the fluid reservoir lands, or droplet impact lands or receiving portions, 207 and before the deposition material has started to flow over the surface.

As indicated on the figure, the wetting properties of the area on which the drain contact 201 is formed vary from an area of lower wetting to an area of higher wetting. This variation of wetting properties produces a variation in depth of the deposition material after it has flowed over the surface, and enables further control over the properties of the electronic device formed, in this case a transistor.

FIG. 20 shows more features of the transistor of FIG. 18, including drain contact connections 220, 222, source contact connections 224, 226, gate contact connections 228, 230, organic semiconductor 232 forming a gate, and gate insulator 234. The gate contact connection 228 has been shown as being partially transparent in the figure to show the location of the organic semiconductor 232 forming the gate:

In the embodiment of FIGS. 18 and 20, the deposition material is a conductor, and is deposited to form the drain contact 201 and the source contact 203. However, in alternative embodiments, the deposition material is an insulator, a semiconductor, or a superconductor, and is deposited to form other devices or other parts of devices.

The feature of variation in wetting properties over the desired portion of a surface is illustrated further with reference to FIG. 21.

A deposition portion 260 of a surface is shown from above in FIG. 21a. The variation in wetting properties of the surface over the deposition portion 260 is shown by the variation in shading. In this example, the deposition portion 260 comprises a desired portion 261 and a receiving portion 264.

Deposition material 262 is deposited on the receiving portion 264 of the surface and then flows to the desired portion 261. The deposition material only covers the deposition portion 260 and not adjacent portions of the surface due to differences in wetting properties between the deposition portion 260 and such adjacent portions.

FIG. 21b shows the deposition portion 260 of the surface in side view following flow of the deposition material 262 over the deposition portion 260. As can be seen, the depth of the deposition material 262 varies over the deposition portion 260, including the desired portion 261, in dependence upon the wetting properties of the surface.

Further layers are added to form an electronic device as required, as shown in FIG. 22 in which a planar semiconductor coating 270 and metal contact layer 272 have been added to the deposition portion of FIG. 21. It can be seen that the deposition material 262, at its thickest point, connects to the metal contact layer 272 to form an electrical circuit interconnection.

In further embodiments, more complex surface patterns comprising areas with different wetting properties are provided, together with a plurality of droplet impact lands, or receiving portions, and deposition material deposited on those lands or receiving portions flows to cover the surface pattern. By controlling the wetting properties of the surface and controlling the deposition of the deposition material, coverage of the surface pattern to a desired depth is obtained in such embodiments. In particular embodiments, a uniform depth of deposition material is obtained on desired portions of the surface.

FIG. 23 shows an example of a circuit produced using a surface pattern which results in two organic field effect transistors being deposited side by side. Connections are made between the transistors to form a NOT circuit. Each of the organic field effect transistors is formed in the same way as the organic field effect transistor of FIGS. 18 and 20.

In alternative embodiments, the containment of the deposition material within a desired surface pattern is assisted by the laying down of other physical surface features such as trenches and wells. The distribution of the deposition material in some embodiments is aided by applying flowing fluid to the deposition material to assist the flow of the deposition material over the surface.

In one embodiment, a channel or gap of known width is created by printing etch resist and UV curing it. Then a solvent based ink, such as antimony tin oxide nanoparticulate dispersion, for transparent conductors, is printed so that it fills the channel created by the etch resist. The conductor material is dried after printing and then the etch resist is removed by soaking in acetone or such like solvent.

In other embodiments, various features described above may be replaced by alternative features.

In particular, the deposition material can comprise any one of a wide variety of inks, including:
Ink suitable for UV curing
Ink suitable for cationic curing
Ink adapted to be subject to a phase change before, during, or following deposition
Solid phase ink
Aqueous-based ink
Organic solvent-based ink
Solutions
Multi-phase ink
Ormocers

Such ink in particular embodiments contains one or more of:
Organic nanoparticles (i.e., pentacene)
Inorganic nanoparticles (i.e., silicon, germanium)
DNA
Carbon nanotubes, fibres, towers, and wires
Molecular species
Rotaxane
Polysilanes and siloles
Polymer(s)
Siloxane
Bioelectronic compounds
Zinc oxide

The ink comprises in certain embodiments, one or more of various modifiers:
Viscosity [Newtonian; shear thinning (pseudo-plastic); shear thickening (dilitant); Bingham]
Surface tension
Electronic conductivity
Light absorbance
Solvent evaporation [humectants]
Dispersants
Surfactants
Elasticity agents
Anti-fungal agents
Chelating agents
pH controllers
Corrosion inhibitors
Defoamers

In an embodiment described above, an ink jet printing technique is used. In alternative embodiments, other methods of dispensing/depositing the deposition material used to build any or all layers of a specific device include:
Corrosion inhibitors
Defoamers
Pin transfer
Nano pipette
Precision impulse spraying [includes electrostatic and nebuliser methods]
Continuous ink jet
Gravure
Flexographic
Offset
Dip (including roll transfer through a fluidised bed)
Solid source ablation
Solid particle ink jet
Semi-solid continuous strip transfer (i.e., like toothpaste with pressure valve pulsing)
Casting
Vapour transfer condensation
Electrophoresis

In further embodiments semi-solid and/or solid materials or particles are steered/deposited on the landing site where they are thermally melted (local or whole area process) and caused to reflow under the action of the ensuing liquid rheology, surface wetting driving forces, and the specific differential surface wetting (liquid)-surface (solid receiving surface) driving energy.

In an embodiment described above, a surface is treated by laser direct ablation. There are alternative methods to achieve localised liquid wetting/dewetting. In alternative embodiments, one or more alternative methods can be used to selectively control or pattern the receiving surface energy, including:
Electrowetting
Surface electronic charge pumping
Roughening
Controlled heterogeneity
Selective imbibition
Surface curvature
Whole area lamp technology [i.e., gas discharge lamp that emulates the properties of an excimer laser but at lower cost]
Solid-state LED or laser in discrete or array format
Selective area deposited SAMs

In some embodiments, the receiving surface laser irradiation includes using the laser not to treat the surface directly but through chemical exchange with laser energy activated species that reside adjacent to the surface to be treated.

In various embodiments, the substrate medium used in device manufacture comprises one or more of:
Glass
Plastic
Metal
Ceramic
Paper
Crystal wafers
Plant surfaces

Such substrate media are either planar or three -imensionally shaped, and where appropriate an initial levelling and electrically conditioning layer is selectively deposited to assist layer adhesion and device performance.

The Applicant asserts design right and/or copyright in the accompanying drawings.

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

We claim:

1.-90. (canceled)

91. An electrical conductor comprising transparent electrically conductive material and at least one conductive track formed from electrically conductive particles and providing a source or sink for electrical charge transport to and from the transparent material.

92. An electrical conductor according to claim 91, wherein the electrically conductive particles are nanoparticles.

93. An electrical conductor according to claim 92, where the nanoparticles have a mean maximum cross-sectional dimension less than 1000 nm.

94. An electrical conductor according to claim 92, where the nanoparticles have a mean maximum cross sectional dimension less than 100 nm, preferably less than 20 nm.

95. An electrical conductor according to claim 91, being formed on a substrate, wherein the transparent electrically conductive material and/or a fluid comprising the electrically conductive particles is selectively deposited on the substrate using a drop-on-demand printing technique.

96. An electrical conductor according to claim 91, wherein the electrically conductive particles are deposited on the or a substrate and are treated after deposition so as to increase the electrical conductivity of said at least one track.

97. An electrical conductor according to claim 95, wherein the deposited electrically conductive particles are caused to form said at least one conductive track, said at least one conductive track being a continuous, discrete, conductive track.

98. An electrical conductor according to claim 91, wherein the track is formed by at least one of sintering, melting, and annealing of at least some of the electrically conductive particles.

99. An electrical conductor according to claim 91 for use in a display device, wherein said at least one conductive track is of such a size as to not be visible to a user during operation of the display device.

100. An electrical conductor according to claim 91, wherein said at least one conductive track has a width equal to or less than 100 microns and preferably equal to or less than 50 microns.

101. An electrical conductor according to claim 91 for use in a display device, wherein said transparent electrically conductive material is adapted to be aligned with a pixel of said display device and preferably said electrical conductor is adapted to act as a source or sink of electrical charge so as to activate or deactivate said pixel.

102. An electrical conductor according to claim 91, wherein the at least one conductive track defines a window, and preferably the transparent electrically conductive material is deposited within said window using the technique of drop-on-demand printing.

103. A method of fabricating an electrical conductor, comprising forming on a substrate a region of transparent electrically conductive material and at least one conductive track, said at least one conductive track being formed from electrically conductive particles and providing a source or sink for electrical charge transport to and from the transparent material.

104. A method according to claim 103, wherein the electrically conductive particles are nanoparticles.

105. A method according to claim 104, wherein the nanoparticles have a mean maximum cross-sectional dimension less than 1000 nm.

106. A method according to claim 104, where the nanoparticles have a mean maximum cross sectional dimension less than 100 nm, preferably less than 20 mn.

107. A method according to claim 103, comprising selectively depositing the transparent electrically conductive material and/or a fluid comprising the electrically conductive particles on the substrate using a drop-on-demand printing technique.

108. A method according to claim 103, comprising depositing the electrically conductive particles on the substrate and treating the electrically conductive particles after deposition so as to increase the electrical conductivity of said at least one track.

109. A method according to claim 107, comprising causing the deposited electrically conductive particles to form said at least one conductive track, said at least one conductive track being a continuous, discrete, conductive track.

110. A method according to claim 103, comprising forming the track by at least one of sintering, melting, and annealing.

111. A method according to claim 103, wherein the electrical conductor is adapted to be used in a display device, and said at least one conductive track is of such a size as to not be visible to a user during operation of the display device.

112. A method according to claim 103, wherein said at least one conductive track has a width equal to or less than 100 microns and preferably equal to or less than 50 microns.

113. A method according to claim 103, comprising aligning said transparent electrically conductive material with a pixel of a display device, and preferably arranging said electrical conductor to act as a source or sink of electrical charge so as to activate or deactivate said pixel.

114. A method according to claim 103, comprising forming the at least one conductive track so as to define a window, and preferably depositing the transparent electrically conductive material within said window using the technique of drop-on-demand printing.

115. A method according to claim 103, wherein the transparent material comprises at least one of a transparent conductive oxide and a transparent polymer.

116. A method according to claim 103, wherein the transparent electrically conducting material has dispersed therein further electrically conductive particles, said further electrically conductive particles having a higher conductivity than the transparent material.

117. A method according to claim 103, wherein the electrically conductive particles are metallic, preferably at least one of silver, gold, copper, aluminium, tin, zinc, lead, indium, molybdenum, nickel, platinum and rhodium particles.

118. A method according to claim 103, wherein at least part of the conductor has a transparency greater than 70%, preferably greater than 80%, at 550 nm wavelength.

119. A method according to claim 103, wherein the at least one conductive track at least partially surrounds the transparent electrically conductive material.

120. A method according to claim 103, wherein said at least one track and the transparent material partially overlap.

121. A method according to claim 103, wherein said at least one track directly contacts the transparent material.

122. A method according to claim 103, comprising providing further, electrically conductive material between said at least one track and the transparent material.

123. A method according to claim 103, wherein the substrate is a transparent substrate.

124. A method according to claim 123, comprising providing further transparent material between the substrate and the transparent electrically conductive material.

125. A method according to claim 103, wherein said at least one conductive track is of lower transparency than the transparent material at 550 nm wavelength.

126. A method according to claim 103, comprising depositing the transparent material over said at least one conductive track.

127. A method according to claim 103, wherein the electrically conductive material comprises a metal with a lower melting temperature than that of the transparent material.

128. A method according to claim 103, wherein at least one of the conductive track and the transparent electrically conductive material is formed using nanotectics.

129. A method according to claim 103, wherein said electrically conductive particles are deposited within grooves formed on a substrate, preferably so as to partially fill the grooves.

130. A method according to claim 129, wherein the grooves are formed in a coating formed on the substrate.

131. A method according to claim 129, wherein the grooves are formed by laser ablation.

132. A method according to claim 103, comprising forming said at least one conductive track in an interdigitated pattern.

133. An electrical conductor according to claim 91, wherein the transparent electrically conductive material is translucent electrically conductive material.

134. A method according to claim 103, wherein the transparent electrically conductive material is translucent electrically conductive material.

135. An apparatus for forming an electrical conductor comprising means for depositing transparent electrically conductive material on a substrate, and means for depositing electrically conductive particles on the substrate so as to form at least one conductive track, said conductive track providing a source or sink for electrical charge transport to and from the transparent material.

136. An apparatus according to claim 134, wherein said means for depositing said transparent electrically conductive material and/or said means for depositing electrically conductive particles comprises a printhead adapted to carry out a drop-on-demand printing technique.

137. An apparatus according to claim 135, comprising means for treating said transparent electrically conductive material and/or said electrically conductive particles, preferably after deposition.

138. An apparatus according to claim 135, wherein said treating means comprises means for at least one of melting, sintering, and annealing.

139. An apparatus according to claim 135, wherein said treating means comprises a laser, preferably mounted on the or a printhead.

140. A display device comprising at least one pixel and an electrical conductor according to claim 91, wherein the transparent electrically conductive material is aligned with said at least one pixel and preferably the electrical conductor acts as a source or sink of electrical charge so as to activate or deactivate said at least one pixel.
